(19) United States
(12) Patent Application Publication
(10) Pub. No.: US 2003/0187740 A1
(43) Pub. Date: Oct. 2, 2003

(54) Advertisement delivery method and advertisement delivery program

(75) Inventors: Shuichi Tanahashi, Kawasaki (JP); Keisuke Igarashi, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/393,977

(22) Filed: Mar. 24, 2003

(30) Foreign Application Priority Data
Mar. 26, 2002 (JP) 2002-085291

(51) Int. Cl. G06F 17/60

(52) U.S. Cl. 705/14

(57) ABSTRACT

An advertisement delivery method and an advertisement delivery program which enable change of an advertisement having an effect of promoting sales of a commodity for each area including a location of a store based on a local weather forecast on a real-time basis. A computer acquires from another computer weather-forecast information for a vicinity of a sales location of a commodity, and determines whether or not the acquired weather-forecast information meets an advertisement-adoption condition which is preset for the commodity. When the weather-forecast information meets the advertisement-adoption condition, the computer links advertisement information for the commodity with document information which is prepared in association with the sales location. Then, the computer outputs to a terminal through the network the document information and the advertisement information linked with the document information, in response to a request from the terminal for acquisition of the document information.

### BACKGROUND OF THE INVENTION

1) Field of the Invention

The present invention relates to an advertisement delivery method and an advertisement delivery program for delivering advertisements online. In particular, the present invention relates to an advertisement delivery method and an advertisement delivery program which can change contents of advertisements when necessary.

2) Description of the Related Art

Currently, various companies are delivering information on themselves through the Internet. For example, each company publishes on homepages through the Internet information including specifications or features of products which are available from the company, so that consumers can browse the published information.

The advertisements delivered through the Internet as above are normally stored in web servers in the form of image data. It is possible to display advertisement images in webpages displayed based on HTML (Hyper Text Markup Language) documents, when inline display of the data of the advertisement images is designated in the HTML documents. (The inline display is insertion of a distinct object in a webpage.)

Generally, advertisement images to be displayed in webpages are predetermined. In order to change the contents of the advertisement images, it is necessary for administrators of websites to edit the contents of HTML documents. In some websites, advertisement images are periodically changed. In this case, advertisement images which are prepared in advance are selected in turn or randomly for display.

In order to enhance the effect of promoting sales of commodities, it is necessary to provide an advertisement meeting consumers' demands, which vary depending on various factors. One of the factors which has an influence on the consumers' demands is a weather condition.

It is well known that sales amounts of some commodities are strikingly changed by influences of weather conditions. Therefore, in the case of seasonal commodities which are influenced by great changes of weather conditions corresponding to season changes, usually, preparations for sales of the seasonal commodities and placement of advertisements of the seasonal commodities in newspapers and the like are made before the seasons corresponding to the seasonal commodities come.

On the other hand, sales amounts of some other commodities vary in response to daily changes of weather conditions. For example, convenience stores are keeping track of relationships between weather conditions and selling commodities by using the POS (Point of Sales) system, and are making changes and arrangement of commodities in stores according to the weather conditions on a daily basis. Thus, it is possible to satisfy customers' demands, and increase the sales amounts. For example, on rainy days, vinyl umbrellas are put on sale at many stores.

However, even when commodities suitable for weather conditions are displayed at stores, consumers other than persons who visit or pass by the stores cannot know the existence of the commodities. Therefore, it is desired that consumers can be informed of availability of a commodity suitable for a specific weather condition by an advance advertisement.

In the above situation, delivery of an advertisement through the Internet is an effective way of advertisement which can be changed as necessary. Nevertheless, it is bothersome for store clerks to edit an HTML document every time the weather condition changes. In addition, it is difficult for a retail dealing company (such as a department store company or a supermarket company) having a nationwide store network to do work for monitoring local weather conditions at the locations of all stores and changing the advertisement.

### SUMMARY OF THE INVENTION

The present invention is made in view of the above problems, and the object of the present invention is to provide an advertisement delivery method and an advertisement delivery program which enable change of an advertisement having an effect of promoting sales of a commodity for each area including a location of a store based on a local weather forecast on a real-time basis.

In order to accomplish the above object, an advertisement delivery method for delivering an advertisement by a first computer through a network is provided. The advertisement delivery method comprises the steps of: (a) acquiring weather-forecast information for a vicinity of a sales location of a commodity, from a second computer which is connected to the first computer through the network; (b) determining whether or not the weather-forecast information acquired in step (a) meets an advertisement-adoption condition which is preset for the commodity; (c) linking advertisement information for the commodity with document information which is prepared in association with the sales location, when the weather-forecast information meets the advertisement-adoption condition; and (d) outputting the document information and the advertisement information linked with the document information to a terminal connected to the first computer through the network, in response to a request from the terminal for acquisition of the document information.

Further, in order to accomplish the above object, an advertisement delivery program for delivering an advertisement through a network is provided. The advertisement delivery program makes a first computer perform a sequence of processing which comprises the steps of: (a) acquiring weather-forecast information for a vicinity of a sales location of a commodity, from a second computer which is connected to the first computer through the network; (b) determining whether or not the weather-forecast information acquired in step (a) meets an advertisement-adoption condition which is preset for the commodity; (c) linking advertisement information for the commodity with document information which is prepared in association with the sales location, when the weather-forecast information meets the advertisement-adoption condition; and (d) outputting the document information and the advertisement information linked with the document information to a terminal connected to the first computer through the network, in response to a request from the terminal for acquisition of the document information.

The above and other objects, features and advantages of the present invention will become apparent from the following description when taken in conjunction with the accompanying drawings which illustrate preferred embodiment of the present invention by way of example.

### BRIEF DESCRIPTION OF THE DRAWINGS

In the drawings:

FIG. 1 is a conceptual diagram illustrating the present invention which is realized in an embodiment;

FIG. 2 is a diagram illustrating an exemplary construction of a web-advertisement provision system;

FIG. 3 is a diagram illustrating a hardware construction of a web server;

FIG. 4 is a function block diagram illustrating an internal construction of the web server;

FIG. 5 is a diagram illustrating an example of a data structure in a content database;

FIG. 6 is a diagram illustrating an example of a data structure in a weather database;

FIG. 7 is a diagram illustrating an example of a data structure of an advertisement-location management table;

FIG. 8 is a diagram illustrating an example of a data structure of store information;

FIG. 9 is a diagram illustrating an example of a data structure of weather-versus-sales information;

FIG. 10 is a diagram illustrating an example of a data structure of an inventory information table;

FIG. 11 is a sequence diagram illustrating a sequence of processing performed by the entire system;

FIG. 12 is a flow diagram indicating a sequence of processing for determining a commodity for special sale based on weather-forecast information;

FIG. 13 is a flow diagram indicating a sequence of processing for canceling a special sale based on weather-observation information;

FIG. 14 is a flow diagram indicating a sequence of processing for adjustment between stocks at stores;

FIG. 15 is a timing diagram illustrating an example of processing for changing an advertisement according to weather-forecast information;

FIG. 16 is a conceptual diagram illustrating examples of determination of commodities for special sale based on weather-forecast information, where the sequence (A) indicates an example of determination of a commodity for special sale at a store in Tokyo, and the sequence (B) indicates an example of determination of a commodity for special sale at a store in Hokkaido;

FIG. 17 is a diagram illustrating an example of a data structure in the content database after a change of a linkage relationship;

FIG. 18 is a diagram illustrating an example of a screen transition in a website when a commodity for special sale is set;

FIG. 19 is a diagram illustrating an example of a time variation of precipitation;

FIG. 20 is a diagram illustrating an example of a weather-variation-versus-sales correspondence table; and

FIG. 21 is a diagram illustrating an example of a deviation-from-normal-versus-sales correspondence table.

### DESCRIPTION OF THE PREFERRED EMBODIMENTS

An embodiment of the present invention is explained below with reference to drawings.

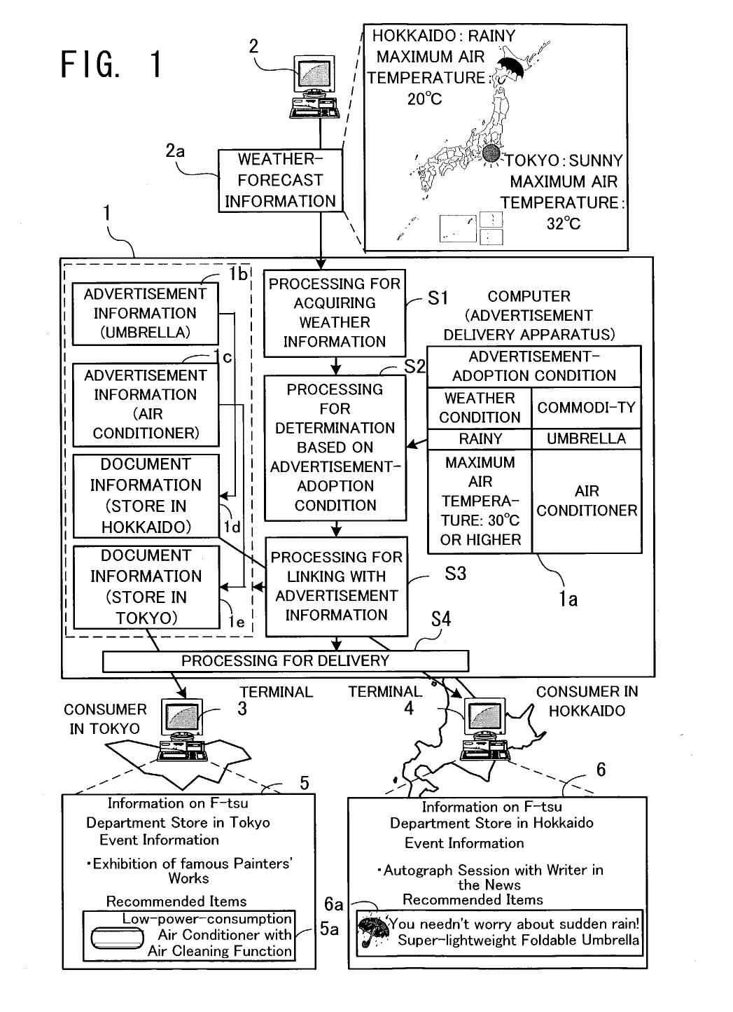

FIG. 1 is a conceptual diagram illustrating the present invention which is realized in the embodiment. According to the present invention, a computer 1 delivers advertisements through a network. When an advertisement delivery program in which details of advertisement delivery processing are described is started, the computer 1 behaves as an advertisement delivery apparatus which executes the advertisement delivery processing.

First, in step S1, the computer 1 acquires from another computer 2 weather-forecast information 2a for at least one vicinity of at least one sales location of at least one commodity. The weather-forecast information 2a is information on a weather forecast for, for example, Tokyo or Hokkaido. In the example of FIG. 1, the weather-forecast information 2a predicts sunny weather and a maximum temperature of 32° C. for Tokyo, and rainy weather and a maximum temperature of 20° C. for Hokkaido. In addition, the “weather-forecast information for at least one vicinity of at least one sales location of at least one commodity” means weather-forecast information for at least one weather forecast point nearest to the at least one sales location of the at least one commodity, where the at least one sales location is, for example, at least one location of at least one store.

Next, in step S2, the computer 1 determines whether or not the acquired weather-forecast information 2a for each sales location meets an advertisement-adoption condition 1a which is preset for each commodity. A weather condition which increases the sales amount of each commodity is preset as the advertisement-adoption condition 1a. In the example of FIG. 1, a weather condition “rain” is set as an advertisement-adoption condition 1a for an umbrella, and a weather condition “hot” (e.g., “30° C. or higher”) is set as an advertisement-adoption condition 1a for an air conditioner.

When weather-forecast information 2a for at least one sales location meets an advertisement-adoption condition 1a, in step S3, the computer 1 links at least one document information item (e.g., the document information items 1d and 1e) with at least one advertisement information item (e.g., the advertisement information items 1b and 1c), where each document information item is prepared in association with a sales location. Since the weather-forecast information 2a predicts the maximum temperature of 32° C. for Tokyo in the example of FIG. 1, the weather-forecast information for Tokyo meets the advertisement-adoption condition 1c for the air conditioner. Therefore, the computer 1 links the advertisement information item 1c for the air conditioner with the document information item 1e prepared in association with Tokyo. In addition, since the weather-forecast information 2a predicts rain for Hokkaido, the weather-forecast information 2a for Hokkaido meets the advertisement-adoption condition 1b for the umbrella. Therefore, the computer 1 links the advertisement information item 1c for the umbrella with the document information item 1d prepared in association with Hokkaido.

In step S4, the computer 1 outputs the document information items 1d and 1e and the advertisement information items 1b and 1c respectively linked with the document information items 1d and 1e to terminals 3 and 4 connected to the computer 1 through the network, in response to requests from the terminals 3 and 4 for acquisition of the document information items 1d and 1e. For example, when the terminal 3, which is used by a consumer in Tokyo, outputs a request for acquisition of the document information 1e corresponding to the store in Tokyo, the computer 1 outputs to the terminal 3 the document information item 1e for Tokyo and the advertisement information item 1c associated with the store in Tokyo. Thus, an advertisement 5a of the air conditioner is displayed on the terminal 3 as well as an image 5 for introducing the store in Tokyo, which is based on the document information item 1e. Similarly, when the terminal 4, which is used by a consumer in Hokkaido, outputs a request for acquisition of the document information 1d corresponding to the store in Hokkaido, the computer 1 outputs to the terminal 4 the document information item 1d for Hokkaido and the advertisement information item 1b associated with the store in Hokkaido. Thus, an advertisement 6a of the umbrella is displayed on the terminal 4 as well as an image 6 for introducing the store in Hokkaido, which is based on the document information item 1d.

According to the above advertisement delivery method, the computer 1 which acquires the weather-forecast information 2a for at least one sales location determines whether or not the weather-forecast information 2a for each sales location meets an advertisement-adoption condition. When the weather-forecast information 2a for some sales locations meets advertisement-adoption conditions, the advertisement information items 1b and 1c are linked with the document information items 1d and 1e which are prepared in association with the sales locations, and the document information items 1d and 1e and the advertisement information items 1b and 1c are output in response to acquisition requests from the terminals 3 and 4.

Therefore, it is possible to change an advertisement having an effect of promoting sales of a commodity for each area including a location of a store based on a local weather forecast on a real-time basis. That is, it is possible to deliver in advance an advertisement of a commodity which meets consumers' demands in each area through a network. Since an advertisement of a commodity meets consumers' demands (which vary according to a weather condition) is delivered, consumers who need the commodity can be informed, in advance, that the commodity is on sale. Thus, it is possible to expect the effect of sales promotion.

In addition, when a commodity for which demands temporarily increase in response to a weather condition is put on a special sale (i.e., sold at a price lower than normal), the sales amount can be further increased.

Further, when the weather-forecast information 2a for a sales location meets advertisement-adoption conditions for more than one commodity, it is possible to deliver an advertisement information item of each of the more than one commodity. However, in the case where only commodities needed by consumers should be placed on a special sale, it is necessary to carefully select a commodity for a special sale. In this case, it is possible to estimate the sales amount of each commodity which can be advertised, based on the weather-forecast information, and determine a commodity corresponding to a greatest estimated sales amount to be a commodity for special sale. That is, a commodity for special sale is determined in decreasing order of the estimated sales amount, and an advertisement of the determined commodity is delivered.

Hereinbelow, the embodiment of the present invention is explained in detail along an exemplary sequence where a commodity for which a greatest sales amount is estimated based on the weather-forecast information is determined to be a commodity for special sale, and an advertisement of the commodity for special sale is delivered through the Internet. In addition, in the embodiment, variations in sales of commodities in a plurality of stores distributed over a wide area are predicted based on local weather-forecast information, and decisions on commodity transfer between the stores and commodity delivery from at least one distribution warehouse are supported.

Further, in the following explanations, it is assumed that the present invention is applied to a web-advertisement provision system in a department store company which has a nationwide store network.

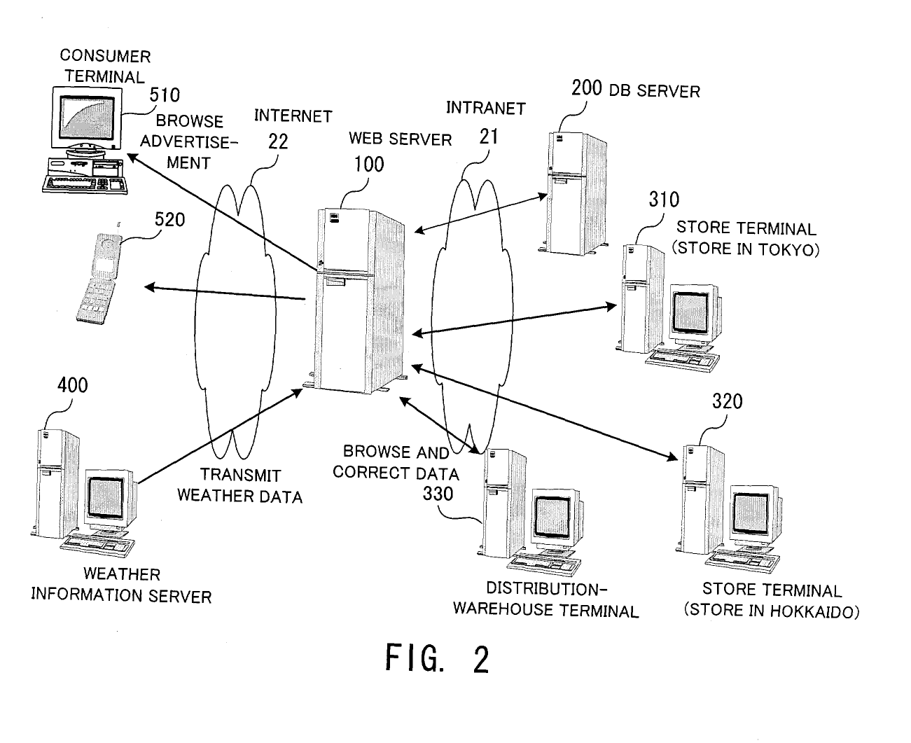

FIG. 2 is a diagram illustrating an exemplary construction of the web-advertisement provision system. The web-advertisement provision system comprises a web server 100, a database (DB) server 200, store terminals 310 and 320, a distribution-warehouse terminal 330, a weather-information server 400, and consumer terminals 510 and 520. The web server 100 is connected through an intranet 21 to the DB server 200, the store terminals 310 and 320, and the distribution-warehouse terminal 330. In addition, the web server 100 is connected through the Internet 22 to the weather-information server 400 and the consumer terminals 510 and 520.

The web server 100 is a server computer for providing a webpage through the Internet 22. The DB server 200 is a server computer holding a database for managing information on commodity inventory, weather, and the like. The store terminal 310 is a client computer placed in a main store of the department store company. It is assumed that an administrator of the web-advertisement provision system belongs to the main store. The store terminal 320 is a client computer placed in each branch store (e.g., a store in Hokkaido) of the department store company. The distribution-warehouse terminal 330 is a client computer for managing distribution of commodities handled by the department store company. The weather-information server 400 is a server computer placed in a company which provides weather forecasts. The weather-information server 400 delivers weather information such as weather-observation information or weather-forecast information through the Internet 22. The consumer terminals 510 and 520 are client computers, portable telephones, personal digital assistants (PDAs), and the like which are used by consumers. The store terminals 310 and 320, the distribution-warehouse terminal 330, and the consumer terminals 510 and 520 each have a function (web browser) for browsing webpages.

In the above system, the web server 100 acquires weather-forecast information from the weather-information server 400, and changes an advertisement to be inserted in a webpage of each store, based on the weather-forecast information. In addition, the web server 100 can output an instruction for delivery of a commodity based on the weather-forecast information.

In the functions of the present embodiment, the DB server 200 stores only the information which is necessary for the web server 100 to perform processing for advertisement delivery. Therefore, the function of the DB server 200 can be built in the web server 100. Thus, in order to simplify the following explanations, the function of the DB server 200 (i.e., the function of storing the weather-forecast information and the like) is assumed to be a part of the functions of the web server 100.

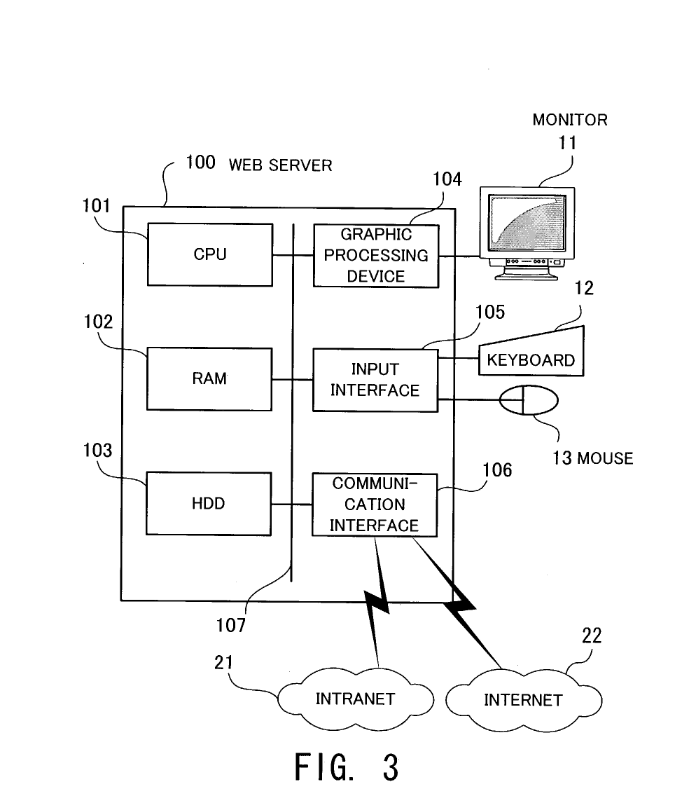

FIG. 3 is a diagram illustrating a hardware construction of the web server. The entire system of the web server 100 is controlled by a CPU (central processing unit) 101, to which a RAM (random access memory) 102, an HDD (hard disk drive) 103, a graphic processing device 104, an input interface 105, and a communication interface 106 are connected through a bus 107.

The RAM 102 temporarily stores at least a portion of an OS (operating system) program and application programs which are executed by the CPU 101, as well as various types of data which are necessary for the CPU 101 to perform processing. The HDD 103 stores the OS program and the application programs.

A monitor 11 is connected to the graphic processing device 104, which makes the monitor 11 display an image on an screen in accordance with an instruction from the CPU 101. A keyboard 12 and a mouse 13 are connected to the input interface 105, which transmits signals transmitted from the keyboard 12 and the mouse 13, to the CPU 101 through the bus 107.

The communication interface 106 is connected to the intranet 21 and the Internet 22. The communication interface 106 is provided for exchanging data with other computers through the intranet 21 and the Internet 22.

By using the above hardware construction, it is possible to realize processing functions in the present embodiment. In addition, each of the DB server 200, the store terminals 310 and 320, the distribution-warehouse terminal 330, the weather-information server 400, and the consumer terminals 510 and 520 can also be realized by using a hardware construction similar to that illustrated in FIG. 3. However, the communication interface 106 in each server or terminal other than the web server 100 is required to be connected to at least one of the intranet 21 and the Internet 22.

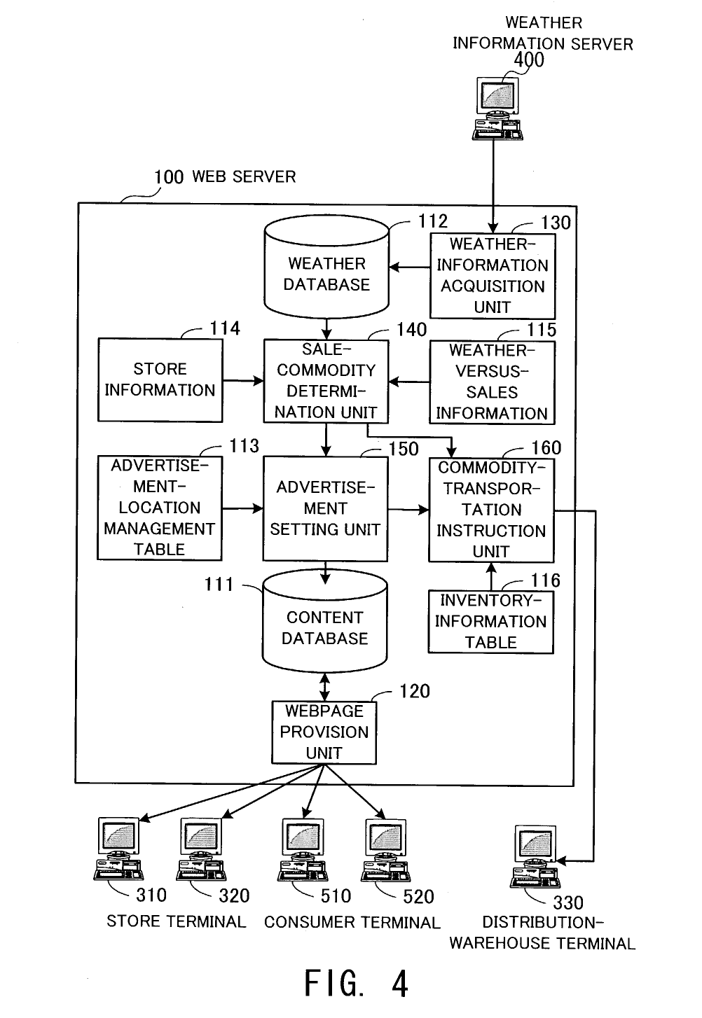

FIG. 4 is a function block diagram illustrating an internal construction of the web server. The web server 100 includes a content database 111, a weather database 112, an advertisement-location management table 113, store information 114, weather-versus-sales information 115, an inventory-information table 116, a webpage provision unit 120, a weather-information acquisition unit 130, a sale-commodity determination unit 140, an advertisement setting unit 150, and a commodity-transportation instruction unit 160. Alternatively, the content database 111, the weather database 112, the advertisement-location management table 113, the store information 114, the weather-versus-sales information 115, and the inventory-information table 116 may be arranged in the DB server 200.

There are connection relationships between ones of the above constituent elements of the web server 100 between which information is exchanged, where the “connection relationships” means existence of an arrangement for information exchange between the ones of the above constituent elements. Specifically, the webpage provision unit 120 is connected to the content database 111, the store terminals 310 and 320, and the consumer terminals 510 and 520. The weather-information acquisition unit 130 is connected to the weather-information server 400 and the weather database 112. The sale-commodity determination unit 140 is connected to the store information 114, the weather-versus-sales information 115, the advertisement setting unit 150, and the commodity-transportation instruction unit 160. The advertisement setting unit 150 is connected to the advertisement-location management table 113, the commodity-transportation instruction unit 160, and the content database 111, as well as the above-mentioned elements. The commodity-transportation instruction unit 160 is connected to the inventory-information table 116, as well as the above-mentioned elements.

The content database 111 is a database which stores webpage information on webpages to be provided to other client computers (such as the store terminals 310 and 320, the consumer terminals 510 and 520, and the like). The webpage information includes HTML documents or XML (eXtensible Markup Language) documents, and image data which are to be inline displayed in the HTML or XML documents. Hereinafter, the webpages are assumed to be described in HTML as a representative example of the above languages.

The weather database 112 is a database for maintaining and managing weather information (such as weather-forecast information and weather-observation information) acquired from the weather-information server 400. The weather database 112 stores weather information for the location of each of the plurality of stores of the department store company. Specifically, the weather information in the weather database 112 is stored in chronological order for each weather element. In addition, “daily maximum values,” “daily minimum values,” “daily variations,” and “deviations from normal values” of the weather elements are registered in the weather database 112 for use in estimation of sales amounts, where each of the “normal values” is an average of values of a weather element on identical days in the preceding thirty years. The weather conditions in the present embodiment are the weather elements (e.g., air temperature, amount of precipitation or probability of precipitation, wind direction, wind speed, amount of insolation, barometric pressure, and the like) and other information generated by combinations of the weather elements, such as the discomfort index.

The advertisement-location management table 113 is a data table for managing a storage location of each advertisement-image data item which is to be displayed according to a weather condition. In the advertisement-location management table 113, a storage location of an advertisement-image data item indicating an advertisement of each commodity is registered in association with a commodity name or a commodity number of the commodity. The storage location is indicated by, for example, an URL (Uniform Resource Locator).

The store information 114 is information indicating the location of each store. For example, latitude and longitude of each store is registered in association with a store name or store number.

The weather-versus-sales information 115 is information indicating how the sales amount of a commodity varies according to a weather condition. That is, a relationship between a “selling commodity” and a “weather condition” under which the commodity is sold is defined in the weather-versus-sales information 115. The variation of the sales amount of each commodity is set in the weather-versus-sales information 115 based on past data (which indicate the sales amounts in association with various weather conditions).

The inventory-information table 116 is a data table in which information on inventory situations for commodities at the plurality of stores and the at least one distribution warehouse is set.

The webpage provision unit 120 acquires from the content database 111 data of a webpage (i.e., an HTML document or image data to be inline displayed) in response to a request from each terminal (each of the store terminals 310 and 320 and the consumer terminals 510 and 520), and then delivers the acquired data to the terminal.

The weather-information acquisition unit 130 periodically acquires from the weather-information server 400 weather information (weather-forecast information and weather-observation information) for various regions. For example, the weather-forecast information is delivered from the weather-information server 400 at intervals of six hours, and the weather-observation information is delivered from the weather-information server 400 at intervals of an hour. The weather-information acquisition unit 130 stores the acquired weather information in the weather database 112.

The sale-commodity determination unit 140 determines an advertisement to be displayed in a webpage for each store, based on newest weather information registered in the weather database 112. In order to determine the advertisement, the sale-commodity determination unit 140 refers to the store information 114 and the weather-versus-sales information 115. Specifically, the sale-commodity determination unit 140 refers to the store information 114, and acquires the location of each store. Then, the sale-commodity determination unit 140 determines a weather condition at the location of each store based on the weather database 112. In addition, the sale-commodity determination unit 140 refers to the weather-versus-sales information 115, and determines a commodity the sales amount of which is maximized under the weather condition at the location of each store. That is, a commodity the estimated sales amount of which becomes greater than the estimated sales amounts of any other commodities being able to be advertised is determined by the sale-commodity determination unit 140 to be a commodity for special sale (a commodity to be advertised). Then, the sale-commodity determination unit 140 determines an advertisement introducing the determined commodity to be an advertisement displayed on a webpage corresponding to the store.

The result of the determination is passed from the sale-commodity determination unit 140 to the advertisement setting unit 150 and the commodity-transportation instruction unit 160. The result of the determination includes the name of the store (or identification information identifying the store) and the name of the determined commodity (or identification information identifying the commodity). In addition, the determination result passed to the commodity-transportation instruction unit 160 includes the estimated sales amount of the commodity for special sale.

The advertisement setting unit 150 edits details of content items registered in the content database 111 in accordance with the result of the determination by the sale-commodity determination unit 140. Specifically, the advertisement setting unit 150 refers to the advertisement-location management table 113, and acquires location information for an advertisement image data item corresponding to the commodity indicated in the result of the determination by the sale-commodity determination unit 140. Then, the advertisement setting unit 150 acquires from the content database 111 an HTML document corresponding to the commodity indicated in the result of the determination by the sale-commodity determination unit 140, and replaces a portion of the acquired HTML document indicating a location of main advertisement image data with the location information acquired from the advertisement-location management table 113. Finally, the advertisement setting unit 150 replaces the original HTML document in the content database 111 with the HTML document in which the above portion indicating the location of the advertisement image data is changed (i.e., stores in the content database 111 the HTML document in which the above portion indicating the location of the advertisement image data is changed, so as to overwrite the original HTML document in the content database 111).

The commodity-transportation instruction unit 160 outputs to the distribution-warehouse terminal 330 an instruction for transportation of a commodity based on the result of the determination by the sale-commodity determination unit 140. Specifically, the commodity-transportation instruction unit 160 determines the stock quantity of the commodity indicated in the result of the determination at the store indicated by the result of the determination by the sale-commodity determination unit 140. When the stock quantity of the commodity at the store is smaller than a quantity of the commodity which is expected to be sold, the commodity-transportation instruction unit 160 outputs to the distribution-warehouse terminal 330 an instruction for transportation of the commodity for special sale from a store (or the distribution warehouse) having sufficient quantity of the commodity in stock to the store at which the special sale is conducted.

Next, data structures of various information stored in the web server 100 are explained below.

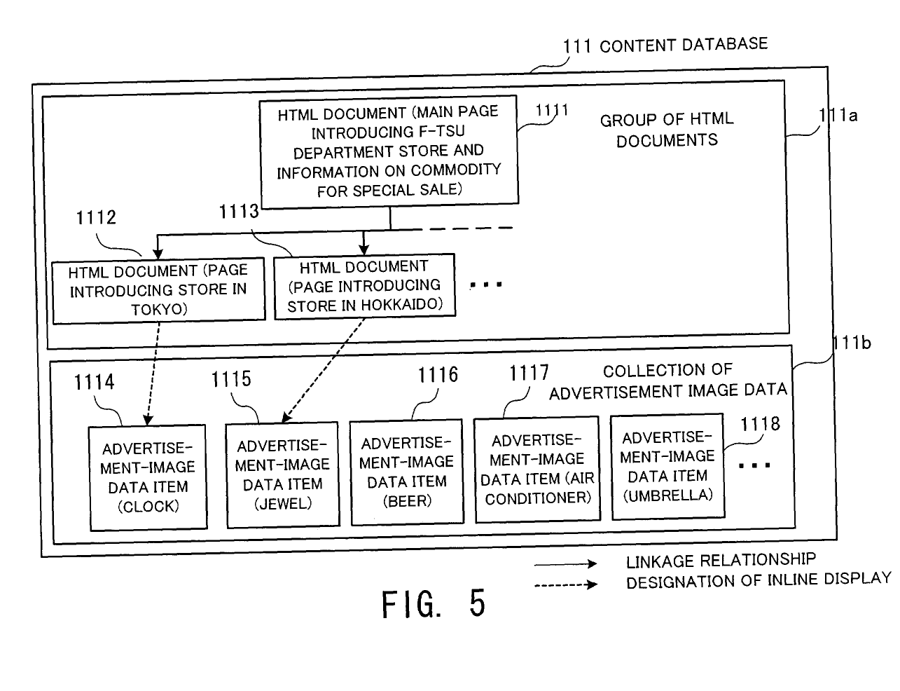

FIG. 5 is a diagram illustrating an example of a data structure in the content database. The content database 111 is a collection of image definition data for displaying websites in which department stores are introduced to consumers and events held in the respective stores are announced to consumers. The content database 111 comprises a group of HTML documents 111a and a collection of advertisement image data 111b.

The group of HTML documents 111a includes HTML documents 1111 to 1113 in which structures of screens (webpages) to be displayed by the terminals are defined. In the HTML document 1111, a screen structure of a main page introducing the F-tsu department store company is defined. In the HTML documents 1112 and 1113, screen structures of pages for introducing respective stores of the F-tsu department store company are defined, where the page defined in the HTML document 1112 introduces the store in Tokyo, and the page defined in the HTML document 1113 introduces the store in Hokkaido.

The HTML documents 1111 to 1113 are linked with each other. In FIG. 5, the linkage relationships are indicated by arrowed solid lines. Each arrowed solid line indicates which HTML document is linked to which HTML document. In the example of FIG. 5, the HTML document 1111 for the main page is linked to the HTML documents 1112 and 1113 for introducing the respective stores.

The collection of advertisement image data 111b includes advertise-image data items 1114 to 1118 for advertisement of commodities. The advertise-image data items 1114 to 1118 each have a data form which enables display by browsers installed in the terminals. In addition, the advertise-image data items 1114 and 1115 are provided for advertisement of commodities the sales amounts of which are not so much affected by weather conditions, and the advertise-image data items 1116, 117, and 1118 are provided for advertisement of commodities the sales amounts of which are strongly affected by weather conditions. Specifically, the advertise-image data item 1114 is provided for advertisement of a clock, and the advertise-image data item 1115 is provided for advertisement of a jewel. Generally, the sales amounts of clocks and jewels are not so much affected by weather conditions. On the other hand, the advertise-image data item 1117 is provided for advertisement of a beer, the advertise-image data item 1118 is provided for advertisement of an air conditioner, and the advertise-image data item 1119 is provided for advertisement of an umbrella. Generally, the sales amounts of beer, air conditioners, and umbrellas are strongly affected by weather conditions.

In the case where inline display of the advertise-image data items 1114 to 1118 for advertisement is designated in the HTML documents 1111 to 1113, the advertise-image data items 1114 to 1118 are displayed in the corresponding webpages when the webpages are displayed on the terminals based on the HTML documents 1111 to 1113. In FIG. 5, the arrowed dashed lines indicate the relationships between the HTML documents 1111 to 1113 which designate the inline display and ones of the advertise-image data items 1114 to 1118 which are designated to be inline displayed. That is, each arrowed dashed line indicates which HTML document designates which advertise-image data item as an object of inline display. In the example of FIG. 5, the advertise-image data item 1114 for the clock is designated as an object of inline display in the HTML document 1112 which specifies a webpage introducing the store in Tokyo, and the advertise-image data item 1115 for the jewel is designated as an object of inline display in the HTML document 1113 which specifies a webpage introducing the store in Hokkaido.

As described above, in the content database 111, the advertise-image data items 1114 and 1115 for commodities which are not so much affected by weather conditions are initially designated as objects of inline display in the HTML documents 1112 and 1113 which specify webpages introducing the respective stores.

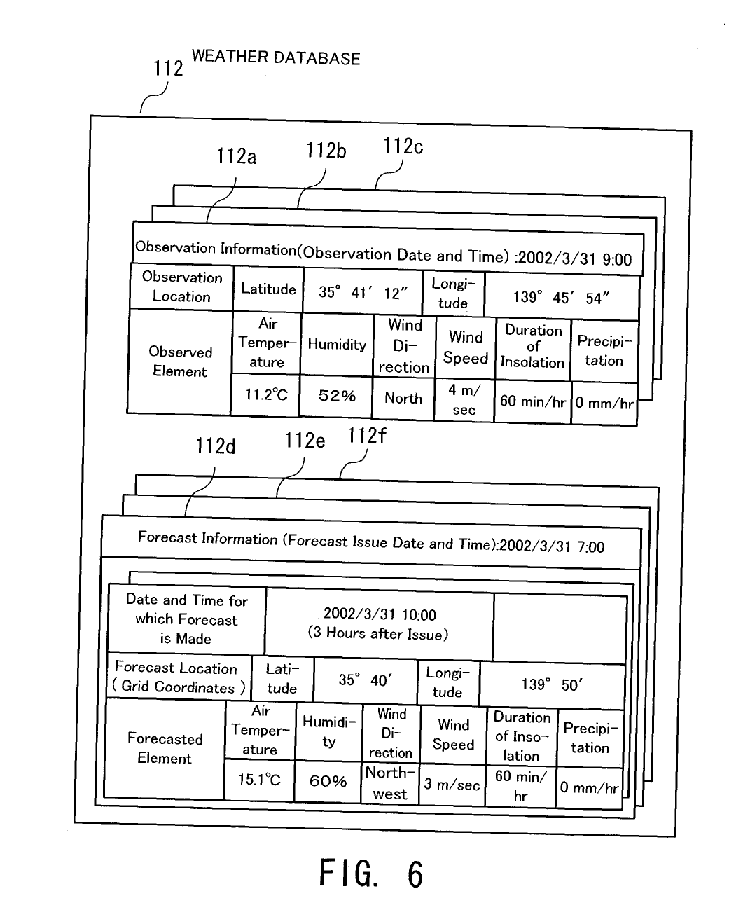

FIG. 6 is a diagram illustrating an example of a data structure in the weather database. The weather database 112 stores a plurality of observation information items 112a, 112b, and 112c and a plurality of forecast information items 112d, 112e, and 112f.

The plurality of observation information items 112a, 112b, and 112c are information items each indicating a result of an actual weather observation at a location. Specifically, in each of the plurality of observation information items 112a, 112b, and 112c, an observation location (latitude and longitude) and observation elements (air temperature, humidity, wind direction, wind speed, duration of insolation, amount of precipitation, and the like) are stored. The observation information items are periodically transferred from the weather-information server 400 to the web server 100 (e.g., at intervals of an hour). In Japan, each observation location may be an observation location in the AMeDAS (Automated Meteorological Data Acquisition System).

The plurality of forecast information items 112d, 112e, and 112f are information items each indicating a future weather condition in a region which a weather forecast company predicts. Specifically, in each of the plurality of forecast information items 112d, 112e, and 112f, a forecast location (grid coordinates of the forecast location represented by latitude and longitude) and forecasted elements (air temperature, humidity, wind direction, wind speed, duration of insolation, amount of precipitation, and the like) are stored for each date and time combination for which a weather condition is predicted. For example, the forecasted elements are provided at intervals of an hour from an hour after the issue of the forecast information item until 18 hours after the issue. The forecast information items are periodically transferred from the weather-information server 400 to the web server 100 (e.g., at intervals of six hours). For example, each forecast location is a location of a mesh of about 10 km.

Each advertisement image to be displayed in a website is determined by using the newest forecast information stored in the above weather database 112.

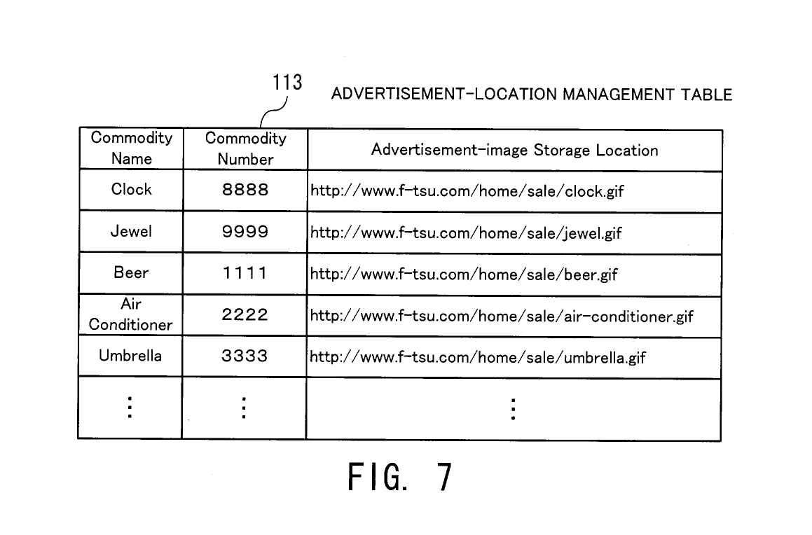

FIG. 7 is a diagram illustrating an example of a data structure of the advertisement-location management table. The advertisement-location management table 113 has the fields of the commodity name, the commodity number, and the advertisement-image storage location. In the field of the communication name, a name of each commodity to be advertised is set. In the field of the commodity number, a commodity number of the commodity is set. Each advertisement-image data item is associated with a weather-condition-versus-sales table in the weather-versus-sales information 115 based on the commodity number. In the field of the advertisement-image storage location, a storage location of an advertisement-image data item corresponding to each commodity is set. For example, the storage location is indicated by an URL.

In the example of FIG. 7, the storage location of an advertisement-image data item corresponding to the communication name “clock” and the commodity number “8888” is “http://www.f-tsu.com/home/sale/clock.gif,” the storage location of an advertisement-image data item corresponding to the communication name “jewel” and the commodity number “9999” is “http://www.f-tsu.com/home/sale/jewel.gif,” the storage location of an advertisement-image data item corresponding to the communication name “beer” and the commodity number “1111” is “http://www.f-tsu.com/home/sale/beer.gif,” the storage location of an advertisement-image data item corresponding to the communication name “air conditioner” and the commodity number “2222” is “http://www.f-tsu.com/home/sale/air-conditioner.gif,” and the storage location of an advertisement-image data item corresponding to the communication name “umbrella” and the commodity number “3333” is “http://www.f-tsu.com/home/sale/umbrella.gif.”

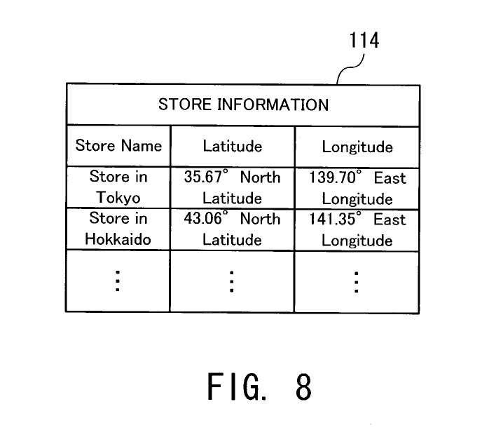

FIG. 8 is a diagram illustrating an example of a data structure of the store information. In the store information 114, the location of each store is set. The store information 114 has the fields of the store name, the latitude, and the longitude. In the field of the store name, the name of each store of the department store company is set. In the field of the latitude, the latitude of the location at which the store is placed is set. In the field of the longitude, the longitude of the location at which the store is placed is set.

In the example of FIG. 8, the store having the name “Store in Tokyo” is placed at the location of “35.67 Degrees North Latitude” and “139.70 Degrees East Longitude,” i.e., in the city of Tokyo, and the store having the name “Store in Hokkaido” is placed at the location of “43.06 Degrees North Latitude” and “141.35 Degrees East Longitude,” i.e., in Hokkaido.

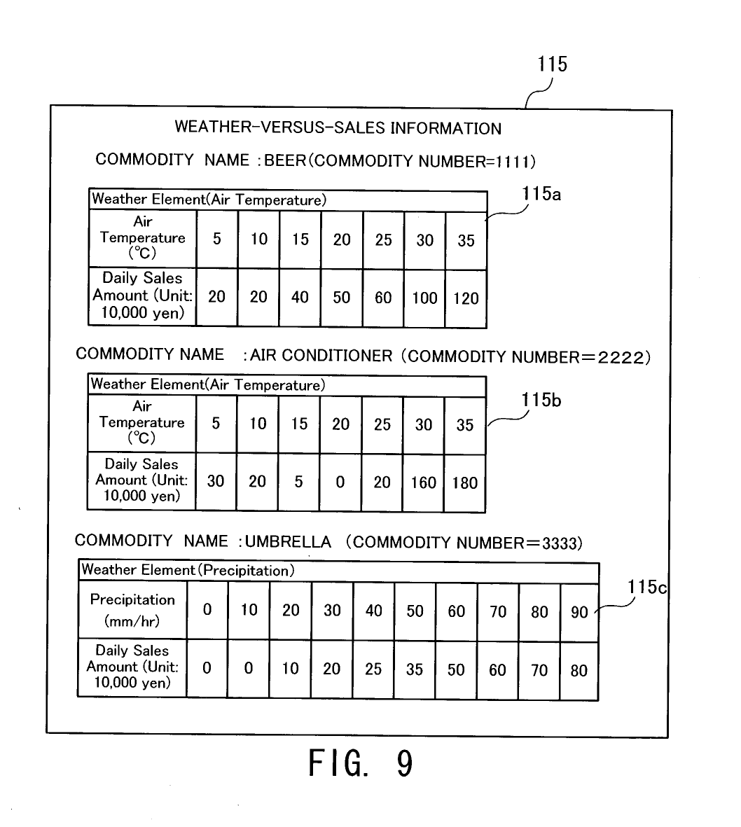

FIG. 9 is a diagram illustrating an example of a data structure of the weather-versus-sales information. In the weather-versus-sales information 115, weather-condition-versus-sales tables 115a, 115b, and 115c for commodities the sales amounts of which are greatly vary with changes in weather conditions are stored. In the example of FIG. 9, the weather-condition-versus-sales tables 115a, 115b, and 115c are respectively provided for the beer, the air conditioner, and the umbrella.

In each of the weather-condition-versus-sales tables 115a, 115b, and 115c, values of weather elements (air temperature, amount of precipitation, and the like) affecting the sales amounts of commodities and the daily sales amounts corresponding to the values of the weather elements are set. The daily sales amounts are numerical values derived from the performance in the past. For example, average values of sales amounts under various weather conditions in the past are set as the daily sales amounts.

In the example of FIG. 9, the weather-condition-versus-sales table 115a for the beer is associated with the commodity name “Beer” and the commodity number “1111.” The weather element with which the sales amount of the beer is linked is the air temperature. The daily sales amount of the beer is 200,000 yen when the air temperature is 5° C., 200,000 yen when the air temperature is 10° C., 400,000 yen when the air temperature is 15° C., 500,000 yen when the air temperature is 20° C. , 600,000 yen when the air temperature is 25° C., 1,000,000 yen when the air temperature is 30° C., and 1,200,000 yen when the air temperature is 35° C.

In addition, the weather-condition-versus-sales table 115b for the air conditioner is associated with the commodity name “Air Conditioner” and the commodity number “2222.” The weather element with which the sales amount of the air conditioner is linked is also the air temperature. The daily sales amount of the air conditioner is 300,000 yen when the air temperature is 5° C., 200,000 yen when the air temperature is 10° C., 50,000 yen when the air temperature is 15° C., 0 yen when the air temperature is 20° C., 200,000 yen when the air temperature is 25° C., 1,600,000 yen when the air temperature is 30° C., and 1,800,000 yen when the air temperature is 35° C.

Further, the weather-condition-versus-sales table 115c for the umbrella is associated with the commodity name “Umbrella” and the commodity number “3333.” The weather element with which the sales amount of the umbrella is linked is the amount of precipitation (per hour). The daily sales amount of the umbrella is 0 yen when the precipitation is 0 mm/hr, 0 yen when the precipitation is 10 mm/hr, 100,000 yen when the precipitation is 20 mm/hr, 200,000 yen when the precipitation is 30 mm/hr, 250,000 yen when the precipitation is 40 mm/hr, 350,000 yen when the precipitation is 50 mm/hr, 500,000 yen when the precipitation is 60 mm/hr, 600,000 yen when the precipitation is 70 mm/hr, 700,000 yen when the precipitation is 80 mm/hr, and 800,000 yen when the precipitation is 90 mm/hr.

As indicated in FIG. 9, the sales amount of the beer increases with the air temperature. The sales amount of the air conditioner is minimized at the air temperature of 20° C., and increases either when the air temperature increases or decreases from 20° C. The sales amount of the umbrella increases with the amount of precipitation.

As explained above, when a relationship between a weather condition and a sales amount of each commodity is known, it is possible to estimate the sales amount of each commodity. Therefore, when an advertisement of a commodity the sales amount of which is estimated to be greatest is displayed at the most conspicuous portion of a homepage, it is possible to sell the commodity to a greater number of consumers.

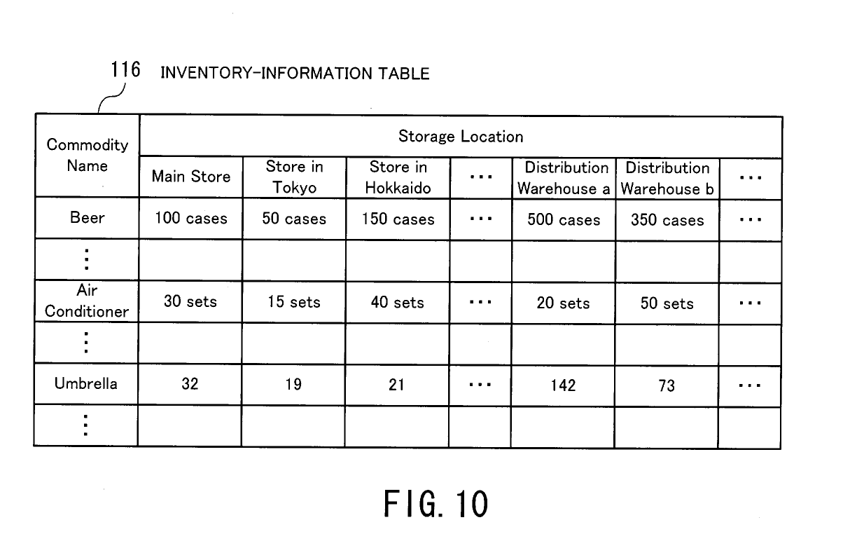

FIG. 10 is a diagram illustrating an example of a data structure of an inventory information table. The inventory information table has the fields of the commodity name and the storage location. In the field of the commodity name, the name of each commodity is set. In the field of the storage location, a stock quantity of each commodity in each storage location is set. Store names and names of distribution warehouses are set as the storage locations.

In the example of FIG. 10, the stock quantity of the beer is 100 cases at the main store, 50 cases in the store in Tokyo, 150 cases in the store in Hokkaido, 500 cases in the distribution warehouse a, and 350 cases in the distribution warehouse b. The stock quantity of the air conditioner is 30 sets in the main store, 15 sets at the store in Tokyo, 40 sets at the store in Hokkaido, 20 sets in the distribution warehouse a, and 50 sets in the distribution warehouse b. The stock quantity of the umbrella is 32 in the main store, 19 at the store in Tokyo, 21 at the store in Hokkaido, 142 in the distribution warehouse a, and 73 in the distribution warehouse b.

Next, details of processing performed in the system having the above constructions and data structures are explained below.

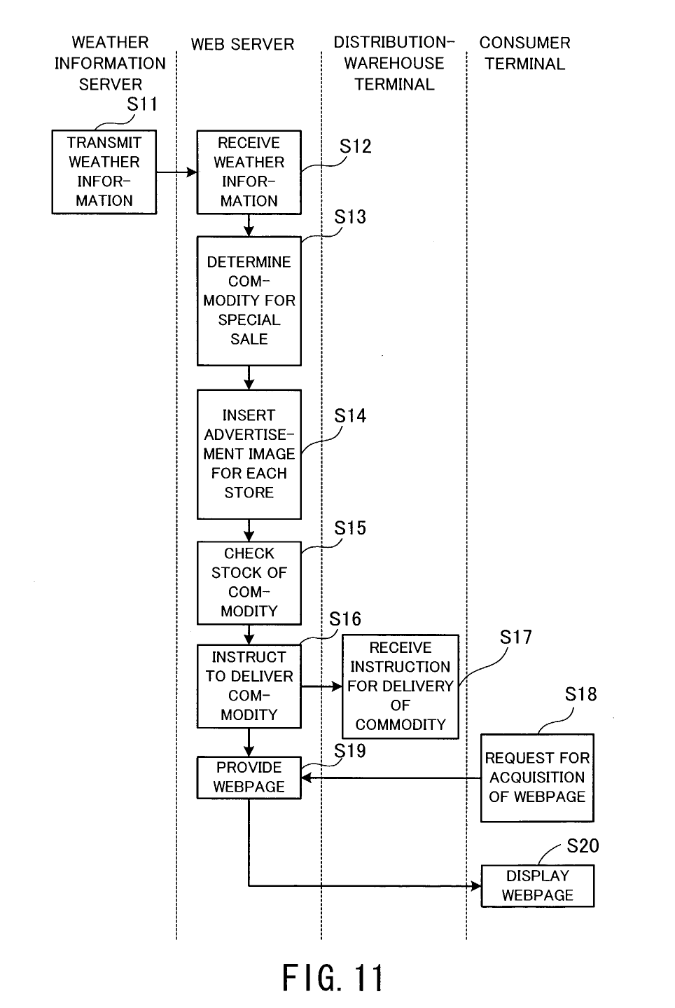

FIG. 11 is a sequence diagram illustrating a sequence of processing performed by the entire system.

In step S11, weather information is transmitted from the weather-information server 400 to the web server 100. In step S12, the weather information is received by the weather-information acquisition unit 130 in the web server 100. In step S13, the sale-commodity determination unit 140 in the web server 100 determines a commodity which is most likely to be sold in each store to be a commodity for special sale, based on the received weather information. In step S14, the advertisement setting unit 150 in the web server 100 inserts an advertisement image for the commodity for special sale in a webpage introducing each store. That is, the advertisement setting unit 150 in the web server 100 inserts in an HTML document corresponding to each store a description for instructing an anchor indication, where an advertisement image data item for the commodity for special sale is designated in the description.

Further, in step S15, the commodity-transportation instruction unit 160 in the web server 100 checks whether or not each store has sufficient quantity of the commodity for the special sale in stock. When shortage of the commodity for the special sale at a store is expected, in step S16, the commodity-transportation instruction unit 160 in the web server 100 outputs to the distribution-warehouse terminal 330 an instruction for delivery of the commodity for special sale from a store having sufficient quantity of the commodity in stock to the store in which the shortage of the commodity is expected. In step S17, the distribution-warehouse terminal 330 receives the instruction for delivery from the web server 100. Thus, a person in charge of delivery in the distribution warehouse can confirm the instruction for delivery by using the distribution-warehouse terminal 330, and do work for delivery of the commodity for special sale.

Thereafter, when, for example, a consumer manipulates the consumer terminal 510 so as to input an instruction for access to the website of the F-tsu department store company (e.g., by inputting an URL of the main page of the F-tsu department store company), the consumer terminal 510 outputs to the web server 100 a request for acquisition of a webpage in step S18. Then, in step S19, the web server 100 delivers a content item (such as an HTML document, an advertisement-image data item, and the like) constituting the webpage to the consumer terminal 510. In step S20, the consumer terminal 510 acquires the content delivered from the web server 100, and displays the webpage based on the content item.

As described above, an advertisement image in a webpage introducing each store can be changed, and delivery of a commodity for special sale can be instructed.

The weather information delivered from the weather-information server 400 includes weather-forecast information which predicts a future weather condition and weather-observation information which indicates a result of the newest observation of weather. In the present embodiment, the web server 100 determines a commodity for special sale on each day according to weather-forecast information received in the morning of the day. In addition, the web server 100 determines whether or not the determined commodity for special sale is appropriate, based on the weather-observation information, and cancels the determination of the commodity for special sale when the determination is inappropriate. Hereinbelow, details of the operations performed by the web server 100 for determination of a commodity for special sale and cancellation of the determination are explained.

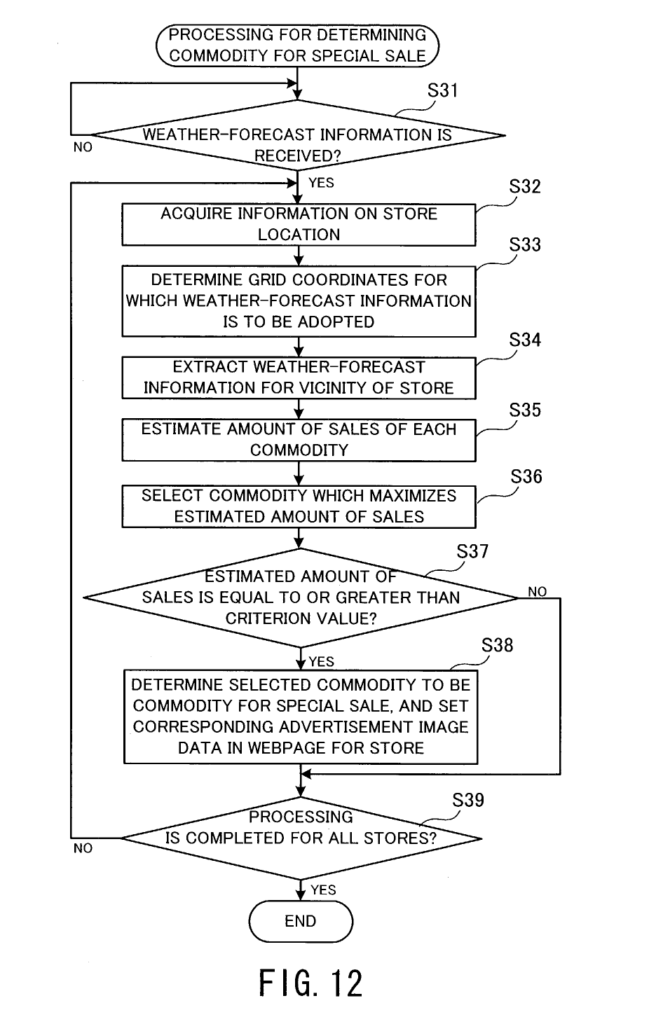

FIG. 12 is a flow diagram indicating a sequence of processing for determining a commodity for special sale based on weather-forecast information. The processing illustrated in FIG. 12 is explained below step by step.

[Step S31] The weather-information acquisition unit 130 determines whether or not weather-forecast information is received from the weather-information server 400. When yes is determined, the weather-information acquisition unit 130 stores the received weather-forecast information in the weather database 112, and the operation goes to step S32. When no is determined, the weather-information acquisition unit 130 repeats the operation in step S31 until weather-forecast information is transmitted from the weather-information server 400.

[Step S32] The sale-commodity determination unit 140 selects one of the stores for which the processing for determining a commodity for special sale has not yet been performed, and acquires from the store information 114 information on the location of the selected store.

[Step S33] The sale-commodity determination unit 140 determines grid coordinates of a grid point for which weather-forecast information is to be adopted, from among grid points for which weather-forecast information is available. Specifically, based on the information on the location of the store, the sale-commodity determination unit 140 determines grid coordinates of one of the grid points nearest to the location of the selected store, to be the grid coordinates of the grid point for which weather-forecast information is to be adopted.

[Step S34] The sale-commodity determination unit 140 acquires from the weather database 112 the newest weather-forecast information (e.g., weather-forecast information for 18 hours beginning from the time of the issue of the weather-forecast information) for the grid coordinates determined in step S33.

[Step S35] The sale-commodity determination unit 140 refers to the weather-versus-sales information 115, and determines an estimated sales amount of each commodity the sales amount of which varies according to a weather condition. Specifically, the sale-commodity determination unit 140 refers to the weather-condition-versus-sales table for each commodity, and then acquires as an estimated sales amount a sales amount corresponding to a forecasted value of a weather element which affects the sales amount.

Since the weather-forecast information includes a plurality of weather forecasts for a plurality of times at intervals of, for example, an hour, the estimated value can be obtained for every time for which a weather forecast is included in the weather-forecast information. Therefore, it is predetermined, for each commodity, which forecasted value is used in determination of the estimated sales amount. For example, in the case where the commodity is an air conditioner, it is possible to adopt a maximum value (e.g., a maximum air temperature) in each day as a forecasted value which is to be used as a reference in determination of a sales amount. Hereinafter, a forecasted value which is to be used as a reference in determination of a sales amount is referred to as a reference forecasted value. Alternatively, in the case where a time period in which a sales amount is affected by a weather condition can be expected, it is possible to adopt as a reference forecasted value an average of forecasted values of a weather element in the time period in which the sales amount is affected. For example, sales amounts of umbrellas are greatly affected by amounts of precipitation in and after the evening. Further, it is possible to adopt a daily average of forecasted values as a reference forecasted value.

In the weather-condition-versus-sales table, values of each weather element are set in predetermined steps. Therefore, the sale-commodity determination unit 140 determines a daily sales amount corresponding to one of the values of the weather element which is nearest to the reference forecasted value, to be an estimated sales amount.

[Step S36] The sale-commodity determination unit 140 selects a commodity which corresponds to the maximum estimated sales amount.

[Step S37] The sale-commodity determination unit 140 determines whether or not the estimated sales amount of the selected commodity is equal to or greater than a criterion value, which is preset. For example, the criterion value may be a sales amount under a normal weather condition in the past. When the estimated sales amount of the selected commodity is equal to or greater than the criterion value, the operation goes to step S38. When the estimated sales amount of the selected commodity is smaller than the criterion value, the operation goes to step S39.

[Step S38] The advertisement setting unit 150 determines the selected commodity as a commodity for special sale, and sets an advertisement-image data item corresponding to the commodity in a webpage of the store selected in step S32.

[Step S39] The sale-commodity determination unit 140 determines whether or not the processing for determining necessity of a commodity for special sale has been completed for all of the stores. When yes is determined, the processing for determining a commodity for special sale is completed. When no is determined, the operation goes to step S32.

As explained above, it is possible to determine a commodity for special sale at each store according to weather-forecast information for the location of the store, and deliver an advertisement of the commodity for special sale through the Internet 22.

In the processing of FIG. 12, the commodity for special sale is determined based on weather-forecast information. However, weather forecasts are not always right. When a weather forecast is not right, it is possible to cancel a special sale of a commodity. A sequence of processing for cancelling a special sale of a commodity is explained below.

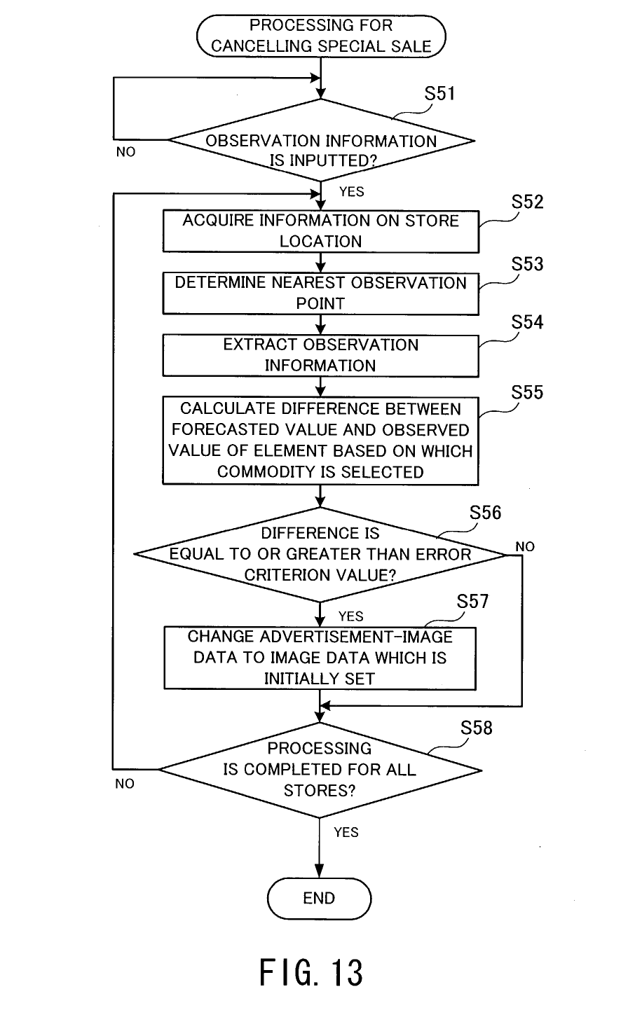

FIG. 13 is a flow diagram indicating a sequence of processing for cancelling a special sale based on weather-observation information. The processing illustrated in FIG. 13 is explained below step by step. In the following explanations with reference to FIG. 13, each reference forecasted value used in the determination of a commodity for special sale is referred to as a forecasted value.

[Step S51] The weather-information acquisition unit 130 determines whether or not weather-observation information is delivered, i.e., whether or not weather-observation information is received. When yes is determined, the weather-information acquisition unit 130 stores the received weather-observation information in the weather database 112, and the operation goes to step S52. When no is determined, the weather-information acquisition unit 130 repeats the operation in step S51 until weather-observation information is transmitted to the web server 100.

[Step S52] The sale-commodity determination unit 140 selects one of the stores for which the processing for cancelling a commodity for special sale has not yet been performed, and acquires from the store information 114 information on the location of the selected store.

[Step S53] The sale-commodity determination unit 140 determines an observation point for which weather-observation information is to be adopted, from among observation points for which weather-observation information is available. Specifically, based on the information on the location of the store, the sale-commodity determination unit 140 determines one of the observation points nearest to the location of the selected store, to be the observation point for which weather-observation information is to be adopted.

[Step S54] The sale-commodity determination unit 140 acquires from the weather database 112 the newest weather-observation information for the observation point determined in step S53.

[Step S55] The sale-commodity determination unit 140 calculates a deviation of an observed value from a forecasted value of an element (e.g., air temperature) of a weather condition based on which the commodity for special sale at the store has been determined.

[Step S56] The sale-commodity determination unit 140 determines whether or not the deviation is equal to or greater than an error criterion value, which is preset, and may be, for example, a value obtained by multiplying the weather forecast value by a coefficient (e.g., 0.1 when an error of 10% is allowed). When the deviation is equal to or greater than the error criterion value, the operation goes to step S57. When the deviation is smaller than the error criterion value, the operation goes to step S58.

The observed value may deviate from the forecasted value in either of a direction in which the sales amount increases and a direction in which the sales amount decreases. Tn step S56, only deviations in the direction in which the sales amount decreases are compared with the error criterion value. For example, when the commodity is a beer, and an observed value of the maximum air temperature is higher than a forecasted value, it is unnecessary to cancel the special sale. Therefore, in this case, the deviation is not regarded as an error.

[Step S57] The advertisement setting unit 150 cancels the special sale of the commodity which has been determined, and restores advertisement-image data in a webpage for the store to an initial state.

[Step S58] The sale-commodity determination unit 140 determines whether or not the processing for determining cancellation of a commodity for special sale has been performed for all of the stores. When yes is determined, the processing of FIG. 13 is completed. When no is determined, the operation goes to step S52.

As explained above, a special sale of a commodity is cancelled when a deviation of weather-observation information from weather-forecast information is recognized to be great. Although only the processing for cancelling a special sale is explained with reference to FIG. 13, instead, a commodity for special sale may be replaced with another commodity based on weather-observation information. In this case, the web server 100 performs processing for determining a commodity similar to the processing of FIG. 12 based on the weather-observation information. Therefore, it is possible to immediately adapt the system to unexpected weather variations.

Next, processing for adjustment between stocks at stores which is performed at the time of determination of a commodity for special sale is explained below.

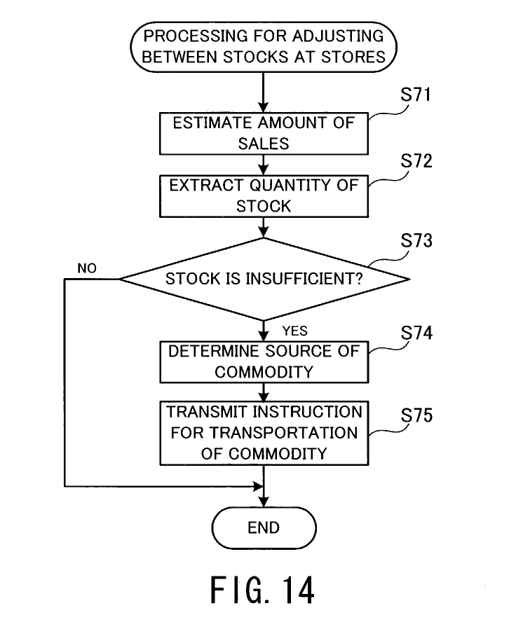

FIG. 14 is a flow diagram indicating a sequence of the processing for adjustment between stocks at stores. The processing illustrated in FIG. 14 is explained below step by step. The processing of FIG. 14 is performed when the sale-commodity determination unit 140 determines a commodity for a special sale.

[Step S71] The commodity-transportation instruction unit 160 estimates a quantity of each commodity for a special sale which is to be sold at a store at which the special sale is conducted. Specifically, the commodity-transportation instruction unit 160 estimates the quantity of the commodity to be sold at the store, by dividing an estimated sales amount by a unit price (i.e., a special price).

[Step S72] The commodity-transportation instruction unit 160 refers to the inventory-information table 116, and extracts a quantity of the commodity for the special sale in stock at the store at which the special sale is conducted.

[Step S73] The commodity-transportation instruction unit 160 determines whether or not stock shortage of the commodity for the special sale occurs at the store at which the special sale is conducted. For example, the commodity-transportation instruction unit 160 determines that stock shortage of the commodity occurs when the quantity of stock is smaller than the estimated quantity of the commodity to be sold. When the commodity-transportation instruction unit 160 determines that stock shortage of the commodity for the special sale occurs, the operation goes to step S74. When the commodity-transportation instruction unit 160 determines that stock shortage of the commodity for the special sale does not occur, the processing of FIG. 14 is completed.

[Step S74] The commodity-transportation instruction unit 160 determines a source of the commodity for the special sale. For example, one of stores under different weather conditions (i.e., one of stores not conducting a special sale of the same commodity) which is located nearest to the store at which the special sale is conducted is determined by the commodity-transportation instruction unit 160 to be the source of the commodity for the special sale.

[Step S75] The commodity-transportation instruction unit 160 transfers to the distribution-warehouse terminal 330 an instruction for transportation of at least a portion of a stock of the commodity for the special sale at the store as the source to the store at which the special sale is conducted, and thereafter the processing of FIG. 14 is completed.

As explained above, when a store in which a special sale is conducted does not have sufficient stock quantity of a commodity for the special sale which is determined according to a weather forecast, the web server 100 outputs to the distribution-warehouse terminal 330 an instruction for delivery in order to replenish the stock of the commodity for the special sale.

Hereinbelow, exemplary applications of the present embodiment are explained.

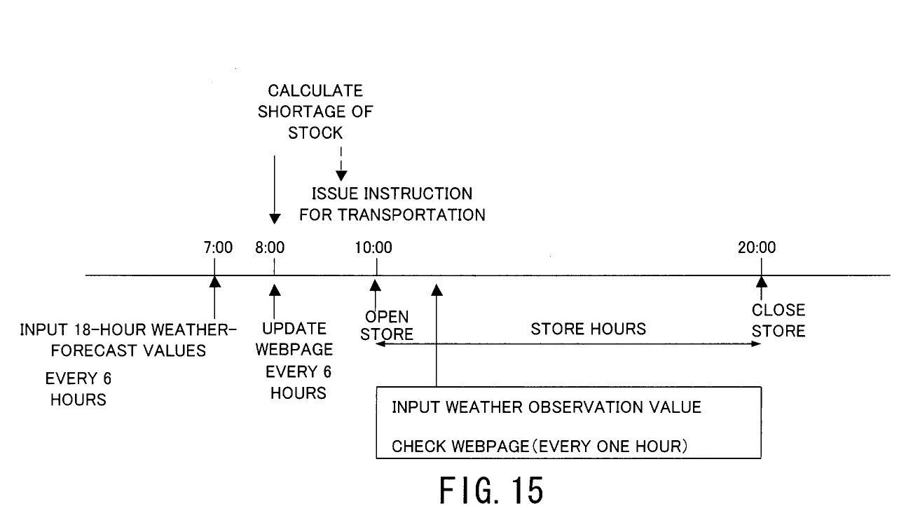

FIG. 15 is a timing diagram illustrating an example of processing for changing an advertisement according to weather-forecast information. In FIG. 15, examples of operations which are performed within a day are indicated along a time axis.

In FIG. 15, at seven o'clock (7:00), weather-forecast information (for 18 hours beginning from the issue of the weather-forecast information) is input into the web server 100. Thereafter, further weather-forecast information is input into the web server 100 every six hours.

At eight o'clock (8:00), the web server 100 determines commodities for special sale, and updates advertisement images in webpages. At the same time, the web server 100 calculates a shortage of a commodity for a special sale at each store conducting the special sale is conducted. When shortage of a commodity for special sale occurs in a store, the web server 100 outputs to the distribution-warehouse terminal 330 an instruction for transportation of the commodity for special sale. Thereafter, weather-observation information is input into the web server 100 every one hour. Every time the weather-observation information is input, the web server 100 determines whether or not cancellation of a special sale of each commodity is necessary, based on the magnitude of a difference between a forecasted value and an observed value.

The stores are opened at ten o'clock (10:00). When the commodities for special sale are conspicuously displayed at the storefront, the sales amounts can be further increased. Since the instruction for transportation of a commodity is output at eight o'clock, when stock replenishment of a commodity is necessary, it is possible to transfer the commodity from another store under a different weather condition, and quickly replenish the commodity. Finally, the stores are closed at twenty o'clock (20:00).

Hereinbelow, concrete examples of determination of a commodity for special sale according to weather-forecast information are explained. Commodities for special sale can be determined based on, for example, a daily maximum or minimum value (e.g., maximum air temperature or maximum precipitation), a daily variation, or a difference from a normal value, which is an average of values on identical days in the preceding thirty years.

First, a concrete example of determination of a commodity for special sale according to a daily maximum or minimum value (e.g., maximum air temperature or maximum precipitation) is explained.

In the following example, a commodity for special sale is determined based on a maximum air temperature and a probability of precipitation in summer. In this case, the sale-commodity determination unit 140 compares a weather forecast in the morning and the weather-versus-sales information 115 (as illustrated in FIG. 9), and estimates a sales amount of each commodity.

When a forecasted value of the maximum air temperature is 30° C., the sales amount of the air conditioner is greatest, and therefore the air conditioner is determined to be a commodity for special sale. Thus, an advertisement image in a webpage is changed to an advertisement of the air conditioner.

When a forecasted value of the maximum air temperature is 20° C., the sales amount of the beer is greater than the sales amount of the air conditioner, and therefore the beer is determined to be a commodity for special sale. Thus, the advertisement image in the webpage is changed to an advertisement of the beer. However, when the maximum precipitation exceeds 70 mm/hr, the sales amount of the umbrella is greater than the sales amount of the beer, and therefore the umbrella is determined to be a commodity for special sale. Thus, the advertisement image in the webpage is changed to an advertisement of the umbrella.

Since a forecasted value is received every six hours, the advertisement of the commodity for special sale in the webpage can be changed every six hours. In addition, a weather-observation value is received every one hour. A difference from the forecasted value is automatically calculated every one hour. When the difference exceeds a preset value, it is determined that the forecast is not right, and the advertisement is replaced with an advertisement of a default commodity.

The above processing is performed for each store. Thus, it is possible to determine a commodity for special sale according to weather at the location of each store on a real-time basis.

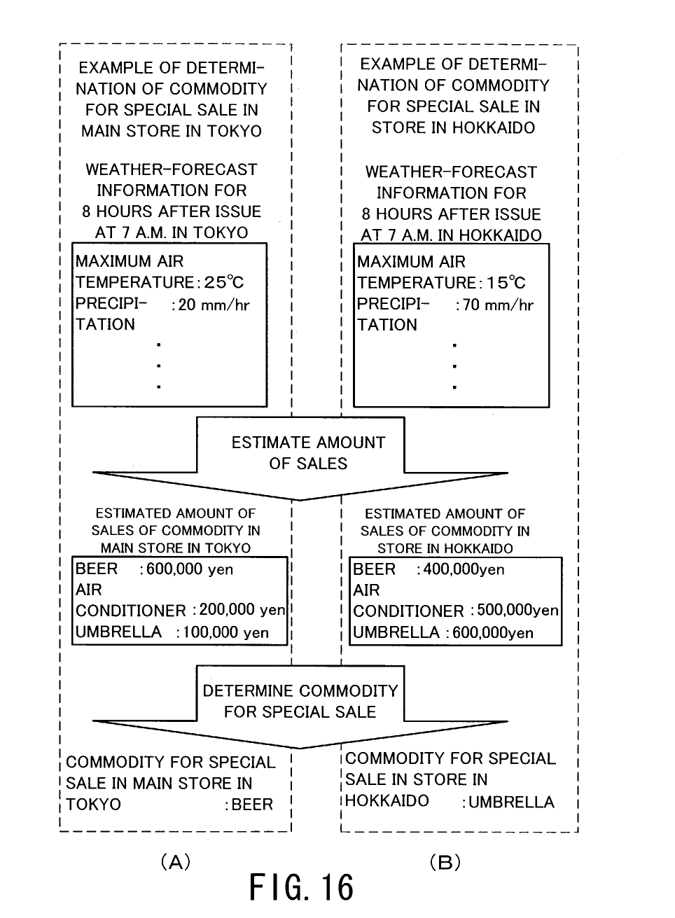

FIG. 16 is a conceptual diagram illustrating an example of determination of commodities for special sale based on weather-forecast information, where the sequence (A) indicates an example of determination of a commodity for special sale at the store in Tokyo, and the sequence (B) indicates an example of determination of a commodity for special sale at the store in Hokkaido.

For example, the commodities for special sale are determined based on daily weather-forecast information announced at seven o'clock. In the examples illustrated in FIG. 16, the daily weather-forecast information for Tokyo predicts a maximum air temperature of 25° C. and a precipitation of 20 mm/hr, and the daily weather-forecast information for Hokkaido predicts a maximum air temperature of 15° C. and a precipitation of 70 mm/hr.

The web server 100 estimates a sales amount of each commodity based on the above weather-forecast information and the weather-versus-sales information 115 (as illustrated in FIG. 9). Since the maximum air temperature in Tokyo is 25° C., the estimated sales amount of the beer at the store in Tokyo is 600,000 yen, and the estimated sales amount of the air conditioner at the store in Tokyo is 200,000 yen. In addition, since the amount of precipitation in Tokyo is 20 mm/hr, the estimated sales amount of the umbrella at the store in Tokyo is 100,000 yen. On the other hand, since the maximum air temperature in Hokkaido is 15° C., the estimated sales amount of the beer at the store in Hokkaido is 400,000 yen, and the estimated sales amount of the air conditioner at the store in Hokkaido is 50,000 yen. In addition, since the amount of precipitation in Hokkaido is 70 mm/hr, the estimated sales amount of the umbrella at the store in Hokkaido is 600,000 yen.

The web server 100 compares the estimated sales amounts of the respective commodities for each store, and determines one of the commodities for which the greatest sales amount is estimated, to be a commodity for special sale at the store. Therefore, the beer is determined to be a commodity for special sale at the store in Tokyo, and the umbrella is determined to be a commodity for special sale at the store in Hokkaido.

When the web server 100 determines the commodities for special sale, the web server 100 updates a webpage for each store. For example, the web server 100 changes the storage location of an advertisement image designated for display of the advertisement image in a webpage introducing each store.

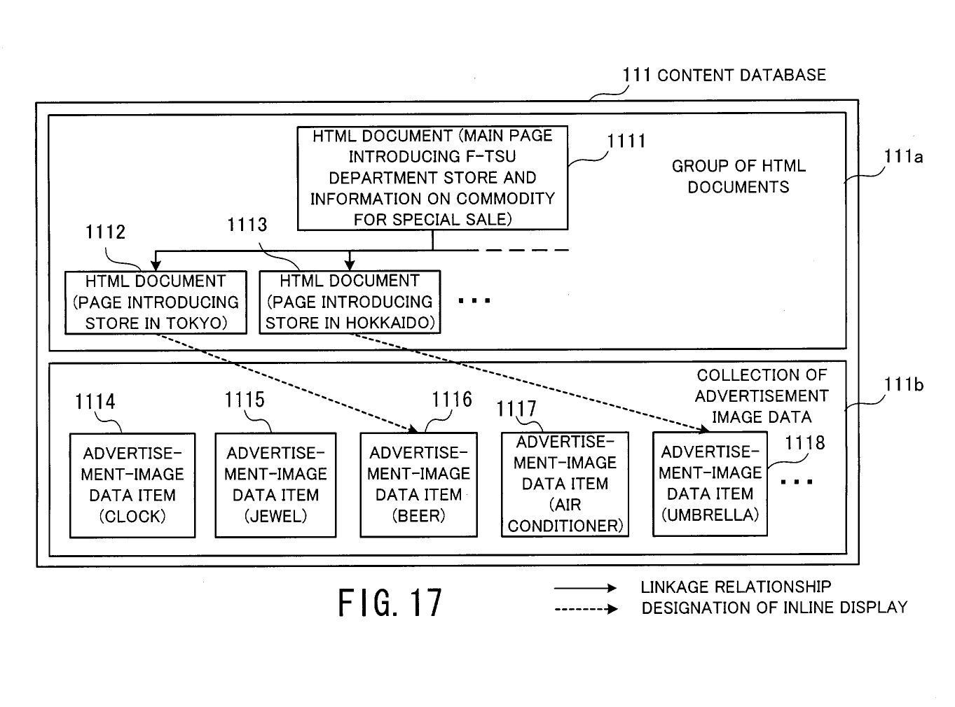

FIG. 17 is a diagram illustrating an example of a data structure in the content database after a change of a linkage relationship. In the state of the content database 111 illustrated in FIG. 17, the designations of inline display of advertisement-image data items in the HTML documents 1111 to 1113 are changed from the initial state illustrated in FIG. 5. For example, in the HTML document 1112 defining the page which introduces the store in Tokyo, the advertisement-image data item 1116 for the beer is designated as an object to be inline displayed. In addition, in the HTML document 1113 defining the page which introduces the store in Hokkaido, the advertisement-image data item 1118 for the umbrella is designated as an object to be inline displayed.

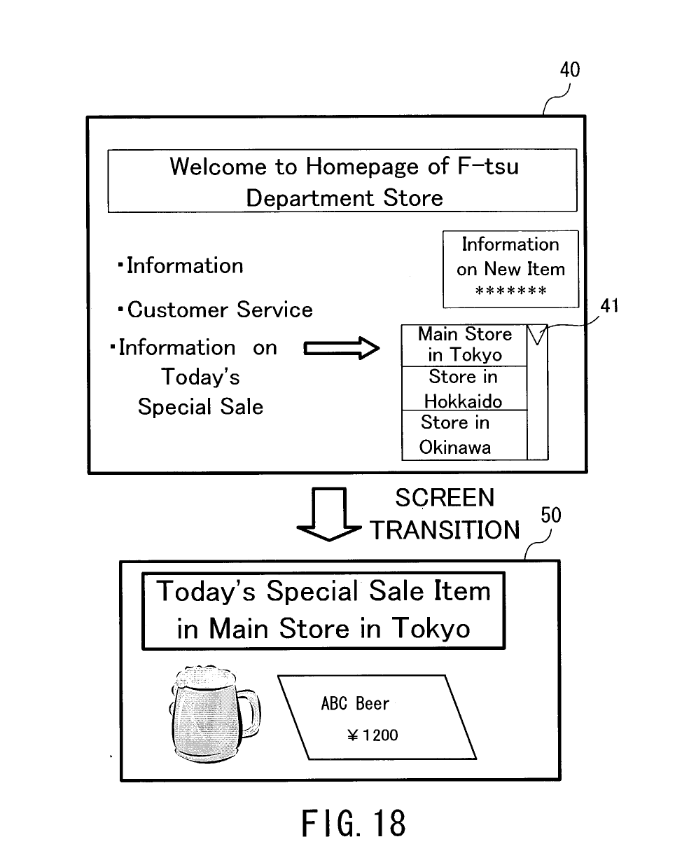

FIG. 18 is a diagram illustrating an example of a screen transition in a website when a commodity for special sale is set. When a consumer accesses a website of the F-tsu department store company in the web server 100 by using the consumer terminal 510, a main page 40 is displayed on the consumer terminal 510. The main page 40 includes a store selection area 41 as well as information for introducing the F-tsu department store company. The store selection area 41 is provided for the consumer to request indication of information on a special sale. In the store selection area 41, the stores belonging to the F-tsu department store company are listed. For example, in the example of FIG. 18, the stores in Tokyo, Hokkaido, and Okinawa are listed. When the store in Tokyo is selected by a manipulation input by the consumer, the screen of the consumer terminal 510 transitions to a special-sale information screen 50 for the store in Tokyo. In the special-sale information screen 50, an advertisement image of a commodity for special sale according to a weather forecast for a vicinity of the store in Tokyo is displayed. In the example of FIG. 18, an advertisement image of ABC beer is displayed.

As explained above, a commodity for special sale at a store located in each region is determined based on weather-forecast information for the region, so that an advertisement of the commodity for special sale can be delivered through the Internet 22. Therefore, when consumers search for commodities which become necessary according to weather conditions, by using the consumer terminals 510 and 520, the consumers can find information on the commodities for special sales in the F-tsu department store company. Thus, it is possible to increase the total sales amount in the F-tsu department store company.

Next, an example of determination of a commodity for special sale based on a daily variation (e.g., a time variation of precipitation) is explained. For example, on a day in which the morning is sunny and the afternoon is rainy, some people go out without an umbrella, and need and purchase an umbrella on their way home. That is, there are relationships between daily variations in weather conditions and selling commodities.

Therefore, the sale-commodity determination unit 140 in the web server 100 obtains quantitative expressions of daily variations based on predetermined formulas. In a method of quantitatively expressing weather variations, a gradient of a curve indicating a time variation of a numerical value indicating a weather element is obtained.

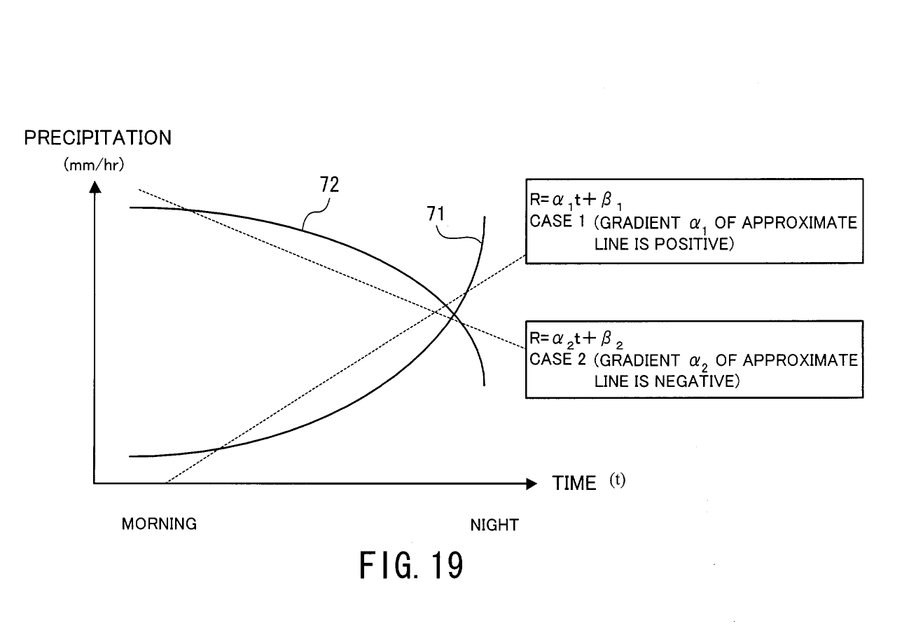

FIG. 19 is a diagram illustrating an example of a time variation of precipitation. In FIG. 19, the abscissa corresponds to time (from 0 o'clock to 24 o'clock), and the ordinate corresponds to the amount of precipitation. FIG. 19 shows first and second cases 71 and 72. In the first case 71, the amount of precipitation is small in the morning, and large in the nighttime. Therefore, an approximation line expressed by the following equation (1) is obtained from the curve in the first case 71.

R=α₁t+β₁, (1)

where R is the amount of precipitation, t is time, α₁ is the gradient of the approximate line, and β₁ is the amount of precipitation at the intersection point of the approximate line and the axis of the precipitation. In the example of FIG. 19, the gradient α₁ of the approximate line in the first case 71 is positive.

In the second case 72, the amount of precipitation is large in the morning, and small in the nighttime. Therefore, an approximation line expressed by the following equation (2) is obtained from the curve in the second case 72.

R=α₁t+β₂, (2)

where α₂ is the gradient of the approximate line, and β₂ is the amount of precipitation at the intersection point of the approximate line and the axis of the amount of precipitation. In the example of FIG. 19, the gradient α₂ of the approximate line in the second case 72 is negative.

At this time, the sale-commodity determination unit 140 estimates the sales amount based on the recognition that the sales amount is greater when the gradient of the approximate line is greater. In the example of FIG. 19, the sales amount in the first case 71 is estimated to be greater than the sales amount in the second case 72.

When a table which shows a relationship between a daily sales amount and the gradient of an approximate line of a curve indicating a daily variation of an amount of precipitation (which is referred to as a weather-variation-versus-sales correspondence table) is prepared in advance, it is possible to determine an estimated sales amount based on the gradient of the approximate line. The weather-variation-versus-sales correspondence table is included in the weather-versus-sales information 115.

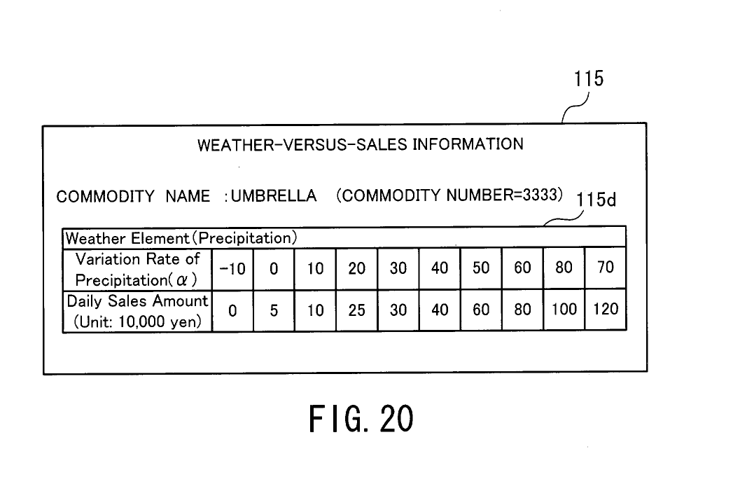

FIG. 20 is a diagram illustrating an example of the weather-variation-versus-sales correspondence table. The weather-versus-sales information 115 includes a weather-variation-versus-sales correspondence table 115d prepared for each commodity. In FIG. 20, the weather-variation-versus-sales correspondence table 115d prepared for only the umbrella is indicated. The precipitation variation rate α quantitatively indicates a hourly variation of the amount of precipitation, and corresponds to the gradient α₁ or β₂ in the equations (1) or (2).

In the example of FIG. 20, the sales amount of the umbrella is 0 yen when the precipitation variation rate α is −10, 50,000 yen when the precipitation variation rate α is 0, 100,000 yen when the precipitation variation rate α is 10, 250,000 yen when the precipitation variation rate α is 20, 300,000 yen when the precipitation variation rate α is 30, 400,000 yen when the precipitation variation rate α is 40, 600,000 yen when the precipitation variation rate α is 50, 800,000 yen when the precipitation variation rate α is 60, 1,000,000 yen when the precipitation variation rate α is 80, and 1,200,000 yen when the precipitation variation rate α is 70.

When the sale-commodity determination unit 140 refers to the above weather-variation-versus-sales correspondence table, the sale-commodity determination unit 140 can estimate the sales amount of the umbrella according to the variation of the precipitation.

Next, an example of determination of a commodity for special sale based on deviation from a normal value is explained. In the following example, a deviation of a discomfort index from a normal value is considered. The discomfort index is calculated based on air temperature and humidity, for example, by using the following formula (3).

Discomfort Index=0.81T+0.01U(0.99T−14.3)+46.3, (3)

where T (° C.) is air temperature, and U (%) is humidity. In Japan, the discomfort index becomes high in the Bai-u (rainy) season. When the discomfort index becomes high, consumers who feel humid tend to purchase dehumidification agent, i.e., the sales amounts of the dehumidification agent in retail stores increase.

The deviation of a forecasted value from a normal value can be calculated from values of hourly forecasted data. It is possible to estimate the sales amount based on the deviation of a forecasted value from a normal value. In order to estimate the sales amount, a table which shows a relationship between a sales amount and a deviation of a forecasted value from a normal value (which is referred to as a deviation-from-normal-versus-sales correspondence table) is prepared in advance. The deviation-from-normal-versus-sales correspondence table can be included in the weather-versus-sales information 115.

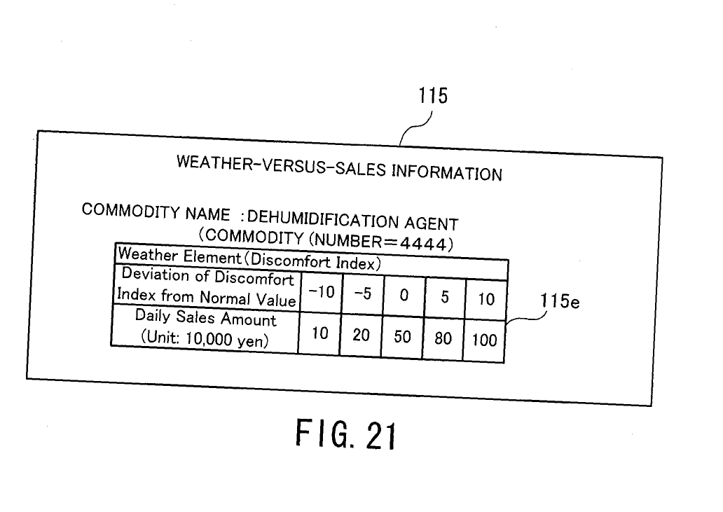

FIG. 21 is a diagram illustrating an example of the deviation-from-normal-versus-sales correspondence table. The weather-versus-sales information 115 includes a deviation-from-normal-versus-sales correspondence table 115e prepared for each commodity. In FIG. 21, the deviation-from-normal-versus-sales correspondence table 115e prepared for only the dehumidification agent is indicated. The sales amount of the dehumidification agent varies with the deviation of the discomfort index from the normal value of the discomfort index.

In the example of FIG. 21, the sales amount of the dehumidification agent is 100,000 yen when the deviation of the discomfort index from the normal value is −10, 200,000 yen when the deviation of the discomfort index from the normal value is −5, 500,000 yen when the deviation of the discomfort index from the normal value is 0, 800,000 yen when the deviation of the discomfort index from the normal value is 5, and 1,000,000 yen when the deviation of the discomfort index from the normal value is 10.

When the sale-commodity determination unit 140 refers to the above deviation-from-normal-versus-sales correspondence table, the sale-commodity determination unit 140 can estimate the sales amount of the dehumidification agent according to the deviation of the discomfort index from an annual average of the discomfort index.

As explained above, the sales amount according to weather-forecast information can be estimated by various methods. The sale-commodity determination unit 140 can determine a commodity for special sale by combining more than one of the above methods. That is, the sale-commodity determination unit 140 can estimate the sales amount of each commodity by using an individually determined method, and determine a commodity for which the greatest sales amount is estimated, to be a commodity for special sale.

The advertisement setting unit 150 identifies the commodity for special sale determined as above based on the commodity number, and an advertisement-image data item corresponding to the commodity number is set in a webpage. Consumers can browse the webpage, obtain information on a special sale at each store, and purchase a necessary commodity at a low price.

On the other hand, a person in charge of each store can make commodity adjustment between respective stores by reference to contents of the webpage, and make decision to transport a commodity from a distribution warehouse. In addition, when a further advertisement of the commodity for special sale is placed in each store, and the commodity is displayed at the store, they can be combined with the advertisement in the webpage, and enhance the advertisement effect. Thus, it is possible to promote sales of the commodity for special sale, and prevent shortage of the commodity for special sale.

Although, in the above embodiment, a commodity the sales amount of which is estimated to be great based on weather-forecast information is determined to be a commodity for special sale, it is possible to merely display an advertisement in a webpage without special sale, and sell the commodity at a normal price. For example, when it is impossible to prepare sufficient quantity of the commodity on the day of the estimation of the sales amount, it is possible to merely display an advertisement in a webpage, and not to put the commodity on special sale (i.e., not to sell the commodity at a low price). That is, in this case, it is possible to sell the commodity in stock at a normal price.

In addition, although, in the above embodiment, an advertisement of the commodity for special sale is prepared in the form of image data, the image data may be either still image data or moving image data. Further, it is possible to display an advertisement including only a catch line (made of characters), instead of the advertisement image, in a webpage. Furthermore, it is possible to display a combination of an advertisement image and a catch line made of characters in a webpage.

In Japan, it is possible to utilize the AMeDAS data as the weather-observation information, and the GPV (Grid Point Value) data as the weather-forecast information, where the GPV data is provided by Japan Meteorological Agency (JMA), and includes the global spectral model (GSM), the regional spectral model (RSM), and the Meso-Scale model (MSM). The object of calculation is the entire global surface in the global spectral model (GSM), and a wide region in east Asia in the regional spectral model (RSM).

For example, in the Meso-Scale model (MSM), 18-hour forecasts (including ground-level data for a plurality of times at intervals of one hour) are issued at 00 o'clock, 06 o'clock, 12 o'clock, and 18 o'clock in the Coordinated Universal Time (UTC). The Meso-Scale model covers a region from 47.6 degrees north latitude and 120 degrees east longitude to 22.4 degrees north latitude and 150 degrees east longitude. In the grid system, parallels of latitude and meridians of longitude are defined so as to form a mesh of 0.1×0.125 degrees on the ground. The weather-forecast information as above can be obtained from, for example, the Japan Meteorological Business Support Center.

In addition, it is possible to independently produce a weather forecast by executing a weather forecast model program on a computer based on the AMeDAS data. In this case, for example, normal values can be used as data for the future which are not included in the forecast period.

Further, the main page which provides contents may be arranged to enable search for a commodity for special sale based on selection of the region, the sales date, or the commodity name. In this case, it is possible to browse information on a special sale of a commodity by specifying a commodity name and a specific day. Furthermore, it is possible to provide in the web server 100 a function of fixing the advertisement information (e.g., to an advertisement of a seasonal commodity) or a function of manually correcting displayed information, in consideration of convenience of sellers (e.g., stock at each store).

When a weather forecast does not come true, it is possible to reduce the size of an advertisement displayed based on a weather forecast issued on the preceding day, and largely display another advertisement based on another weather forecast issued on the day of the display. In addition, it is possible to indicate on the webpage screen a comment that the above advertisements are displayed based on the weather forecasts.

Further, when store clerks in each store arrange in-store display of advertisements and commodities so as to match with an advertisement delivered through the Internet, it is possible to enhance the effect of sales promotion.

Furthermore, when past weather data, advertisements displayed in the past, and results of sales are stored in a database, and reflected in the weather-versus-sales information 115, it is possible to enhance the accuracy of the determination of the estimated sales amount. Therefore, a commodity for special sale can be accurately selected, and the accuracy of the advertisement effect can be increased.

The weather information currently available through a network includes: “Tsunami Jishin Jouhou” (tidal-wave-and-earthquake information) in Japanese, “Kazan Jouhou” (volcano information) in Japanese, various weather warnings and advisories, weather information (such as information on typhoon locations), various forecasts such as “Chijou Kaijou Jouhou” (ground-and-ocean forecast) in Japanese, data used for long-term forecasts (such as monthly averages of surface weather elements), AMeDAS data, “Tokushu Kishyou Hou” (special weather reports) in Japanese for yellow wind, tornadoes, and the like, data for aerometeorology such as “Teiji/Tokushu Koukuu Kishyou Jikkyou Hou” (regular/special aviation-weather sequence report) in Japanese, and the like, ocean information such as “Kaihyou Yohou” (sea ice forecast) in Japanese, “Kaihyou Jouhou” (sea ice information) in Japanese, the numerical forecast GPV (including the surface GPV and the ocean-wave GPV), data used for long-term forecasts such as “Kitahankyuu Kaimen Kiatsu” (northern-hemisphere sea-level pressures) in Japanese, and quantitative forecasts such as “Chihou Tenki Bunpu Yohou” (local weather distribution forecast) in Japanese.

Although the two networks (the intranet 21 and the Internet 22) are used in the system construction illustrated in FIG. 2, it is possible to perform all communications through the Internet 22.

In order to realize the above processing functions by the web server 100, a server program describing details of the processing functions which the web server 100 should have is provided. In this case, the web server 100 executes the server program in response to requests from the terminals. Thus, the above processing functions can be realized on the web server 100, and processing results are supplied to the terminals.

The server program describing the details of the processing functions can be stored in a recording medium which can be read by the web server 100. The recording medium may be a magnetic recording device, an optical disk, an optical magnetic recording medium, a semiconductor memory, or the like. The magnetic recording device may be a hard disk drive (HDD), a flexible disk (FD), a magnetic tape, or the like. The optical disk may be a DVD (Digital Versatile Disk), a DVD-RAM (Random Access Memory), a CD-ROM (Compact Disk Read Only Memory), a CD-R (Recordable)/RW (ReWritable), or the like. The optical magnetic recording medium may be an MO (Magneto-Optical Disk) or the like.

In order to put the server program into the market, for example, it is possible to sell a portable recording medium such as a DVD or a CD-ROM in which the server program is recorded.

The web server 100 which executes the server program stores the server program in a storage device belonging to the web server 100, where the server program is originally recorded in, for example, a portable recording medium. Then, the web server 100 reads the server program from the storage device, and performs processing in accordance with the server program. Alternatively, the web server 100 may directly read the server program from the portable recording medium for performing processing in accordance with the server program.

As explained above, according to the present invention, when weather-forecast information for a location of sales of a commodity meets an advertisement-adoption condition, advertisement information for the commodity is linked with document information, and outputted to a terminal. Therefore, it is possible to deliver, in advance, the advertisement information for the commodity meeting consumers' demands, which depend on a weather condition at the location of sales of the commodity.

The foregoing is considered as illustrative only of the principle of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

What is claimed is:

1. An advertisement delivery method for delivering an advertisement by a first computer through a network, comprising the steps of:
(a) acquiring weather-forecast information for a vicinity of a sales location of a commodity, from a second computer which is connected to the first computer through said network;
(b) determining whether or not said weather-forecast information acquired in step (a) meets an advertisement-adoption condition which is preset for said commodity;
(c) linking advertisement information for said commodity with document information which is prepared in association with said sales location, when said weather-forecast information meets said advertisement-adoption condition; and
(d) outputting said document information and said advertisement information linked with said advertisement information to a terminal connected to the first computer through said network, in response to a request from the terminal for acquisition of the document information.

2. The advertisement delivery method according to claim 1, wherein a condition on a sales amount of said commodity is set as said advertisement-adoption condition, and when said first computer acquires said weather-forecast information, said first computer estimates a sales amount of said commodity under a weather condition which said weather-forecast information predicts, and determines whether or not the estimated sales amount meets said advertisement-adoption condition.

3. The advertisement delivery method according to claim 2, wherein said advertisement-adoption condition is that the estimated sales amount of said commodity is greater than sales amounts estimated for other commodities which are designated as objects of advertisement.

4. The advertisement delivery method according to claim 2, wherein said advertisement-adoption condition is that the estimated sales amount of said commodity is greater than a predetermined criterion value.

5. The advertisement delivery method according to claim 2, wherein in order to estimate the sales amount of the commodity, the first computer refers to weather-versus-sales information in which values of the sales amount of the commodity are set in association with values of a predetermined weather element constituting said weather condition, and determines one of the values of the sales amount corresponding to one of the values of the predetermined weather element included in said weather-forecast information, to be the estimated sales amount of the commodity.

6. The advertisement delivery method according to claim 2, wherein in order to estimate the sales amount of the commodity, the first computer refers to weather-versus-sales information in which values of the sales amount of the commodity are set in association with values of a variation rate of a predetermined weather element constituting said weather condition, and determines one of the values of the sales amount corresponding to one of the values of the variation rate of the weather element included in said weather-forecast information, to be the estimated sales amount of the commodity.

7. The advertisement delivery method according to claim 2, wherein in order to estimate the sales amount of the commodity, the first computer refers to weather-versus-sales information in which values of the sales amount of the commodity are set in association with values of a difference between a forecasted value and a normal value of a predetermined weather element constituting said weather condition, and determines one of the values of the sales amount corresponding to a difference between a value of the weather element included in said weather-forecast information and the normal value of the weather element, to be the estimated sales amount of the commodity.

8. The advertisement delivery method according to claim 2, wherein in order to estimate the sales amount of the commodity, the first computer refers to weather-versus-sales information in which values of the sales amount of the commodity are set in association with values of a predetermined weather interpretation index used for interpreting said weather condition, calculates a forecasted value of the weather interpretation index based on said weather-forecast information, and determines one of the values of the sales amount corresponding to the forecasted value of the weather interpretation index, to be the estimated sales amount of the commodity.

9. The advertisement delivery method according to claim 8, wherein said weather interpretation index is a discomfort index calculated based on air temperature and humidity.

10. The advertisement delivery method according to claim 1, wherein said advertisement information is image data for informing consumers of a special sale.

11. The advertisement delivery method according to claim 1, wherein when said weather-forecast information meets said advertisement-adoption condition, said first computer determines whether or not a store in the sales location has sufficient stock quantity of said commodity, and outputs an instruction for delivery of the commodity from a place other than the store to the store when it is expected that shortage of the commodity occurs at the store.

12. An advertisement delivery program for delivering an advertisement through a network, said advertisement delivery program makes a first computer perform a sequence of processing which comprises the steps of:
(a) acquiring weather-forecast information for a vicinity of a sales location of a commodity, from a second computer which is connected to the first computer through said network;
(b) determining whether or not said weather-forecast information acquired in step (a) meets an advertisement-adoption condition which is preset for said commodity;
(c) linking advertisement information for said commodity with document information which is prepared in association with said sales location, when said weather-forecast information meets said advertisement-adoption condition; and
(d) outputting said document information and said advertisement information linked with said advertisement information to a terminal connected to the first computer through said network, in response to a request from the terminal for acquisition of the document information.

13. An advertisement delivery apparatus for delivering an advertisement through a network, comprising:
weather-forecast-information acquisition means which acquires weather-forecast information for a vicinity of a sales location of a commodity, from a computer which is connected to said advertisement delivery apparatus through said network;
determination means which determines whether or not said weather-forecast information acquired by said weather-forecast-information acquisition means meets an advertisement-adoption condition which is preset for said commodity;
linking means which links advertisement information for said commodity with document information which is prepared in association with said sales location, when said weather-forecast information meets said advertisement-adoption condition; and
delivery means which outputs said document information and said advertisement information linked with said advertisement information to a terminal connected to said advertisement delivery apparatus through said network, in response to a request from the terminal for acquisition of the document information.

14. A computer-readable recording medium which stores an advertisement delivery program for delivering an advertisement through a network, said advertisement delivery program makes a first computer perform a sequence of processing which comprises the steps of:
(a) acquiring weather-forecast information for a vicinity of a sales location of a commodity, from a second computer which is connected to the first computer through said network;
(b) determining whether or not said weather-forecast information acquired in step (a) meets an advertisement-adoption condition which is preset for said commodity;
(c) linking advertisement information for said commodity with document information which is prepared in association with said sales location, when said weather-forecast information meets said advertisement-adoption condition; and
(d) outputting said document information and said advertisement information linked with said advertisement information to a terminal connected to the first computer through said network, in response to a request from the terminal for acquisition of the document information.
